(19) United States
(12) Patent Application Publication
(10) Pub. No.: US 2008/0168175 A1
(43) Pub. Date: Jul. 10, 2008

(54) METHOD AND SYSTEM FOR LOCAL SEARCH AND SOCIAL NETWORKING WITH CONTENT VALIDATION

(76) Inventor: Truong Tran, Seattle, WA (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(21) Appl. No.: 11/619,766

(22) Filed: Jan. 4, 2007

(51) Int. Cl. G06F 15/16

(52) U.S. Cl. 709/229

(57) ABSTRACT

A social networking and local search service validates content including personal information, business information, text, photographs, music, video and/or other media or content. The service provides each member of with the ability to author and share content with the fellow members and visitors. In an embodiment of the invention, if a member claims to be a business owner and provides content for a local business, then the website performs validation functions to authenticate the business information. This allows the website to host only accurate information and allows small businesses to effectively advertise their merchandise.

### FIELD OF THE INVENTION

The present invention is directed to social networking and local search service websites. More specifically, the present invention is directed to a multiple service site having a content validation process.

### BACKGROUND OF THE INVENTION

Since the advent of the Internet and the World Wide Web, online social networking has been a growing phenomenon. Social networking websites are those that enable members to generate their own content and share it with fellow members of the website. Social networking websites are first formed when founding members invite friends, family, and colleagues to join the website. New members repeat this process by inviting their own friends, family, and colleagues. Once a member joins the social networking website, they enjoy the ability to generate their own content (such as text, music, photographs, or video), upload it to their web space on the site, and share it with fellow members. Moreover, traditional social network websites have evolved to some extent into blended social networking sites that combine online social networking with offline elements such as music concerts, professional meetings, and promotional events. This provides complementing synergy between members' online social networking and their offline real world experience.

Similar to the social networking phenomenon, local search services have been a growing resource benefiting both local businesses and consumers via the Internet. Local businesses provide information to local search services to provide advertising to consumers. Conversely, consumers gather information on local businesses from local search services. These websites not only provide business information (such as hours of operation, description of goods and services, accepted payment methods, etc.) but also provide business reviews authored by other consumers.

However, business owners typically have no control over the content displayed by the local search service regarding their business. Rather, local search services either compile their own information or purchase third party business information databases. There is thus a risk that the business content on these websites will be either inaccurate or incomplete. For example, a local business may provide the local search service with the incorrect hours of operation of a competitor to gain a competitive advantage. Similarly, a business may post an unfairly harsh critical review of a competing local business.

### BRIEF SUMMARY OF THE INVENTION

The present invention overcomes many shortcomings in the art by providing support for social networking and local searching. In an embodiment, a website validates business content on a social networking and local search service. The hosted content can include personal and business information, text, photographs, music, video and any other media or content suitable for transmission and display via the Internet. In addition, embodiments of the present invention provide each member of a website with the ability to author their own content and share it with the website's fellow members and visitors. In another embodiment of the invention, if a member claiming to be a business owner provides content for a local business, the website performs validation functions to authenticate the business information. This allows the website to host accurate information, allows small businesses to effectively advertise their merchandise, and allows consumers to search local business information. In another embodiment of the present invention, a website that takes advantage of the benefits of both a social networking site and a local search service by allowing business owners to author their own business content and share it with fellow members, while providing a local search service. This eliminates the need for the website operator to continually the website's business' information and provides control to the business owners, while providing consumers with accurate information on local businesses. The data sharing and access architecture according to various embodiments of the invention incorporates other features and advantages that will be more fully appreciated from the following description in conjunction with the accompanying figures.

### BRIEF DESCRIPTION OF THE SEVERAL VIEWS OF THE DRAWINGS

FIG. 1 is a flow diagram illustrating a method for a visitor to view, register, and generate content in accordance with an embodiment of the invention;

FIG. 2 is a diagram providing a general overview of the operation of a system contemplated by an embodiment of the present invention;

FIG. 3 is a diagram of an exemplary user interface of an embodiment of the present invention;

FIGS. 4a and 4b are diagrams of exemplary user interfaces in accordance with an embodiment of the present invention;

FIG. 5 is a flow diagram illustrating a method for a member to generate different types of content in accordance with an embodiment of the invention;

FIG. 6 is a diagram of an exemplary user interface in accordance with an embodiment of the present invention;

FIG. 7 is a diagram of an exemplary user interface allowing a member to generate photographic content according to an embodiment of the present invention;

FIG. 8 is a flow diagram illustrating a method for a member to generate photographic content in accordance with an embodiment of the invention;

FIG. 9 is a diagram of an exemplary user interface allowing a member to generate photographic content according to an embodiment of the present invention;

FIG. 10 is a diagram of an exemplary user interface allowing a member to edit photographic content according to an embodiment of the present invention;

FIG. 11 is a diagram of an exemplary user interface allowing a member to add photographic content according to an embodiment of the present invention;

FIG. 12 is a diagram of an exemplary user interface allowing a member to add photographic content, one photograph at a time, according to an embodiment of the present invention;

FIGS. 13a-f are diagrams of exemplary user interfaces allowing a member to add photographic content, one photograph at a time, according to an embodiment of the present invention;

FIGS. 14a-d are diagrams of exemplary user interfaces allowing a member to add photographic content, several photographs at a time, according to an embodiment of the present invention;

FIG. 15 is a flow diagram illustrating a method for a member to generate business content in accordance with an embodiment of the invention;

FIG. 16 is a flow diagram illustrating the validation of business ownership status in accordance with an embodiment of the invention;

FIGS. 17a-f are diagrams of exemplary user interfaces allowing a member to view, create, or edit business content, according to an embodiment of the present invention;

FIGS. 18a-d are diagrams of exemplary user interfaces allowing a member to verify her ownership status for generating business content, according to an embodiment of the present invention;

FIG. 19 is a flow diagram illustrating a method for a member to generate Community content in accordance with an embodiment of the invention;

FIG. 20 is a flow diagram illustrating a method for a member to generate Event content associated with business content, in accordance with an embodiment of the invention;

FIG. 21 is a diagram of an exemplary user interface allowing a member to view, create, or edit Event content, according to an embodiment of the present invention; and

FIG. 22 is a diagram of an exemplary user interface setting forth the guidelines for authoring Event content, according to an embodiment of the present invention.

### DETAILED DESCRIPTION OF THE INVENTION

The present invention is a combination of a social networking site and a local search service (SNS-LSS). It provides each member of its website the ability to author their own content, and share it with fellow members and visitors of the website. In addition, if the member claims to be a business owner and provides content allegedly associated a local business, the website performs validation functions to authenticate the business information.

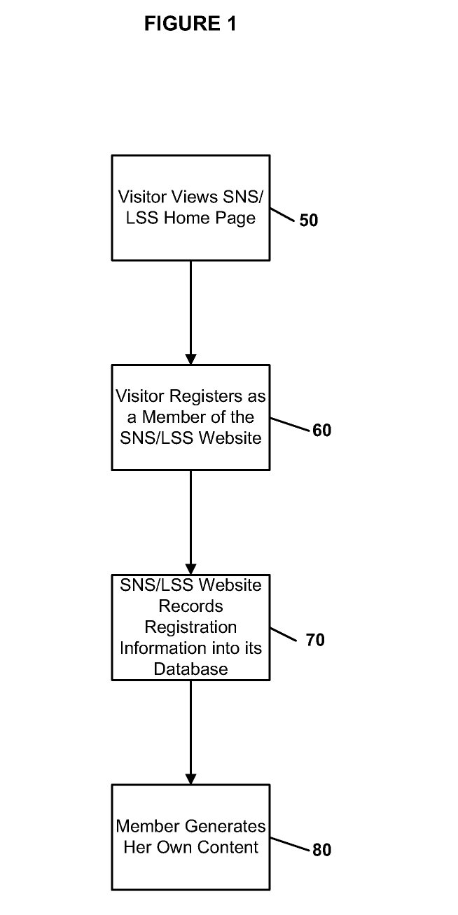

FIG. 1 is a flow diagram illustrating a method for a visitor to register, view content, and generate content in accordance with an embodiment of the invention. The flow diagram displays some of the broad steps taken within an embodiment of the invention. First, a visitor views the SNS-LSS web site's Home Page at stage 50. Next, the visitor registers as a member of the SNS-LSS website at stage 60. At stage 70, the SNS-LSS website records the visitor's registration information into its member database and designates the visitor as a member of the SNS-LSS website. Lastly, the member can generate her own content onto her web space or home page on the SNS-LSS website in stage 80.

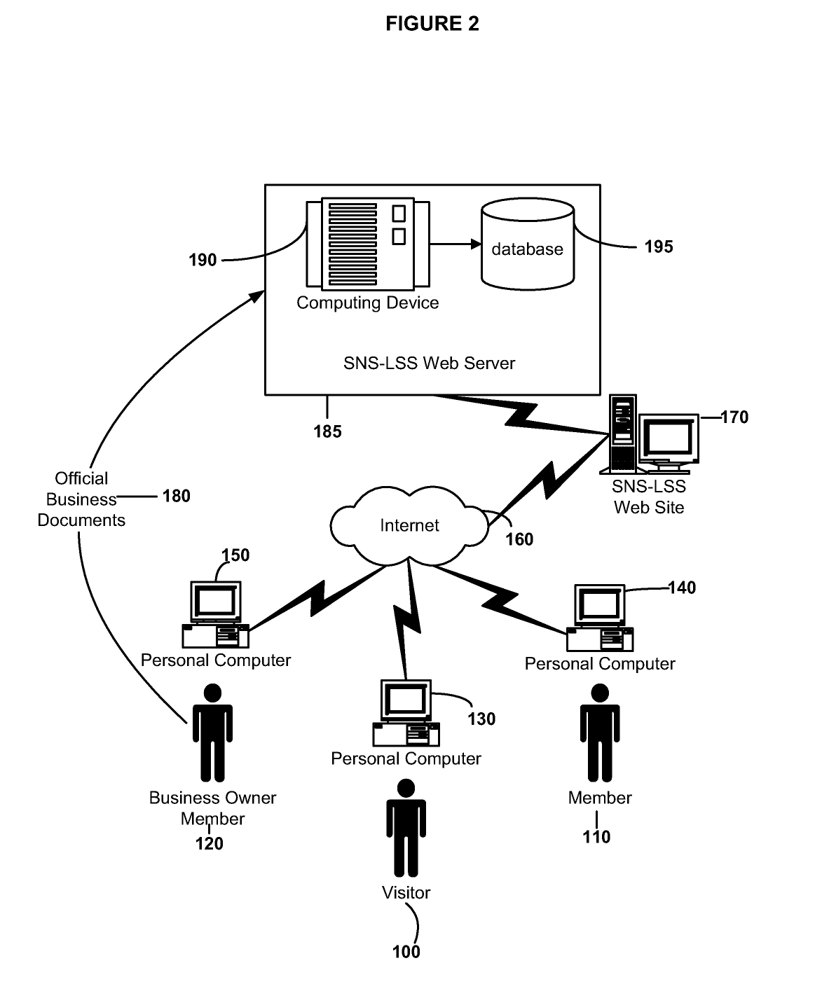

FIG. 2 is a diagram providing a general overview of the elements and information flow within an embodiment of the present invention. A visitor 100 to the SNS-LSS website 170 can access it through his or her personal computer 130 via the Internet 160. The visitor 100 can register as a member by using online tools and accessing web pages on the SNS-LSS website. Once the visitor enters his or her registration information, the SNS-LSS website transmits the information to its web server 185 and records it into its member database 195.

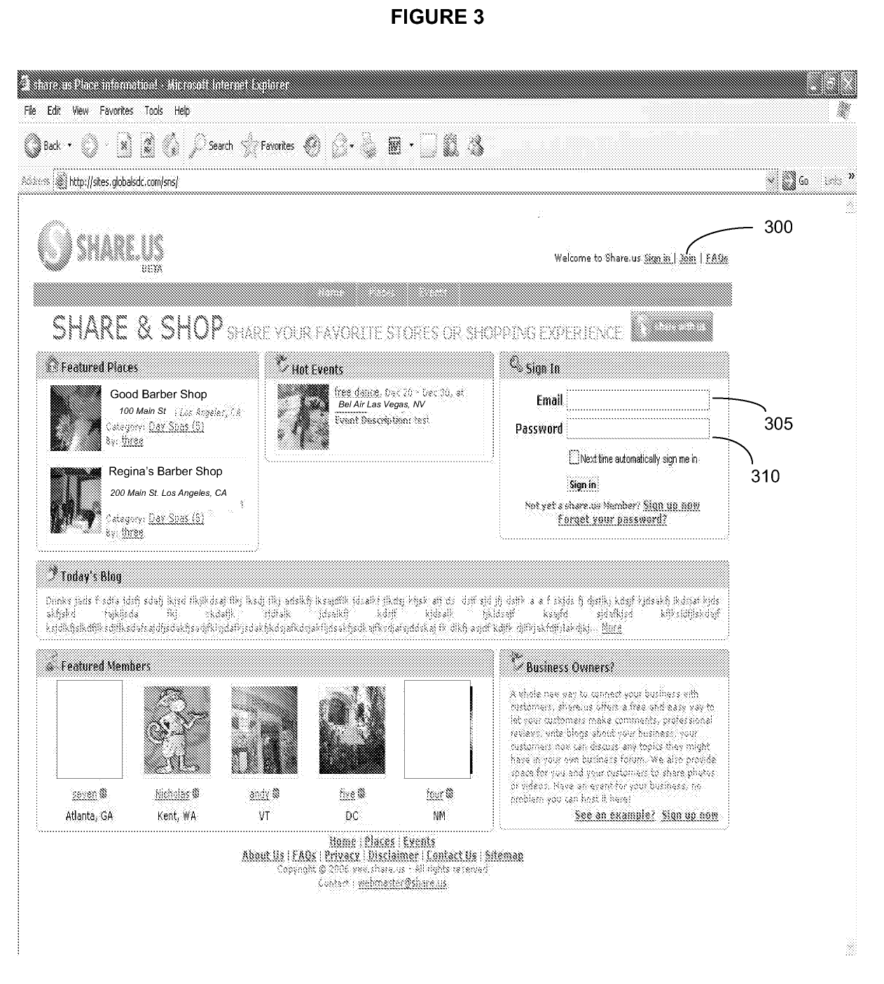

FIG. 3 is a diagram of an exemplary user interface according to an embodiment of the present invention. In particular, FIG. 3 shows an example of a home page of an SNS-LSS website. The home page has several areas of content including “Featured Places,” “Hot Events,” “Today's Blog,” and “Featured Members.” If a visitor wishes to join the social networking community of the SNS-LSS website, they need only click on the “Join” link 300, and then register as a member.

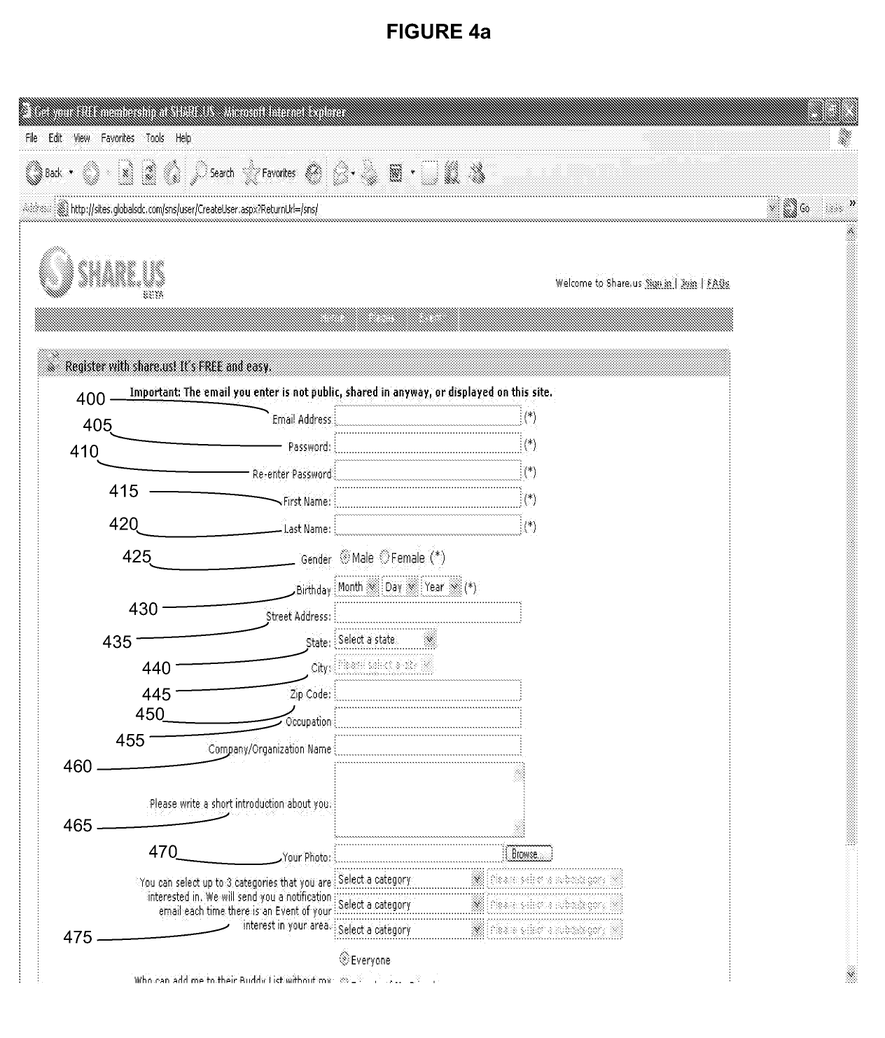

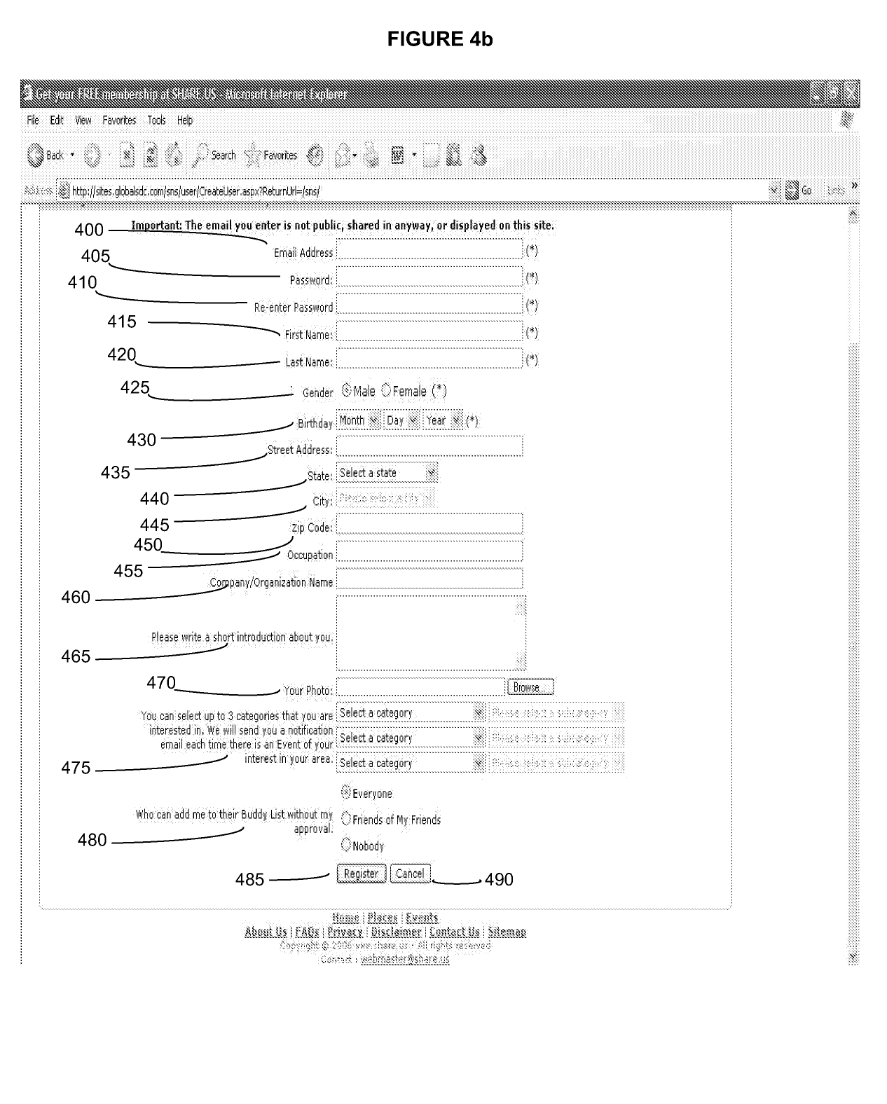

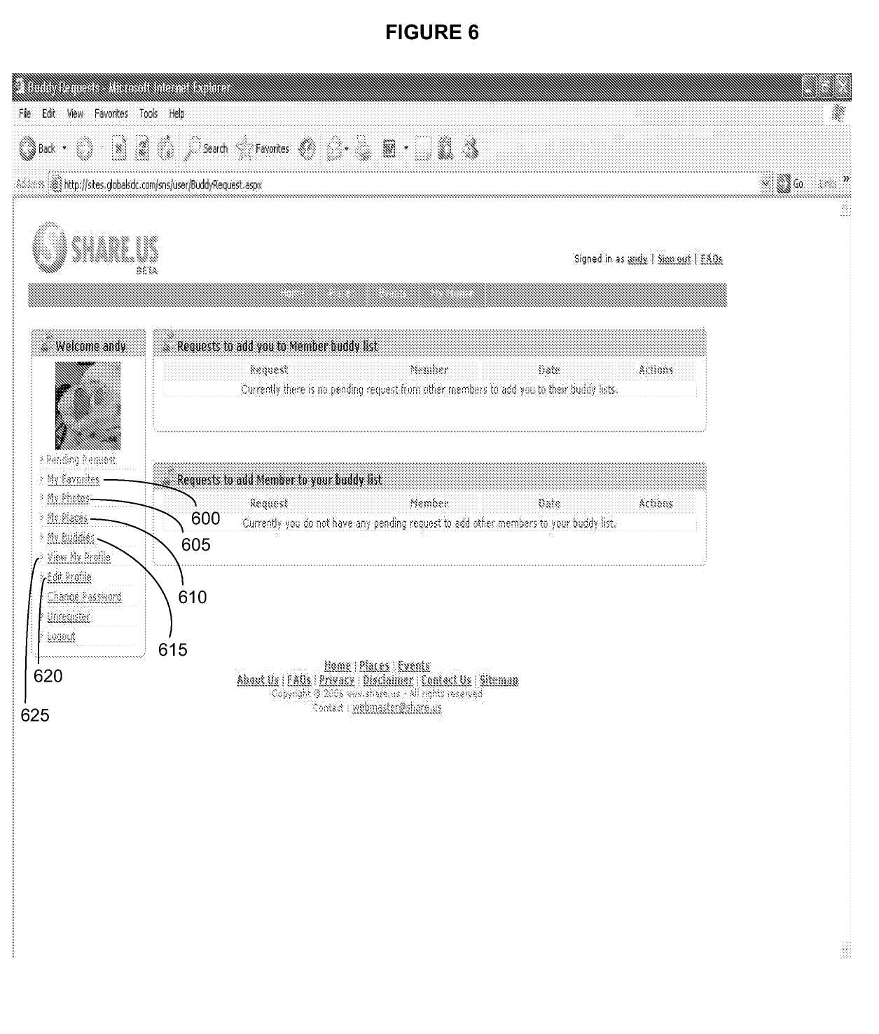

FIGS. 4a and 4b are diagrams of exemplary user interfaces in accordance with an embodiment of the present invention. Specifically, FIGS. 4a and 4b display an example of a registration page of an SNS-LSS website. FIG. 4a shows a first portion of the page while FIG. 4b displays a second portion. Once a visitor reaches this web page, they will enter several pieces of information to register as a member of the SNS-LSS website. In the illustrated example, the visitor enters an email address 400, 410, a password 405, first and last name (415,420), gender, 425, and birthday 430. The visitor may enter additional information such as address (435, 440, 445, and 450), occupation 455 and employer 460, a short introduction 465, and a photograph 470. In addition, the visitor may enter up to three categories of interests 475 and Buddy List permissions 480. Once the indicated information is entered, the visitor may press the “Register” button 485 on the bottom of the registration web page, or elect to cancel the registration process via “Cancel” button 490. Once the visitor selects the “Register” button, their information is recorded into a database 195 by the SNS-LSS website (See FIG. 2). The website then allows the member to view their Member Home Page where they can generate their own content (See FIG. 6). During subsequent visits to the SNS-LSS website, the user must log into the website through the Home Page by entering the user's email address 305 and password 310 (See FIG. 3).

After a member registers, the system transmits an email with an activation link to the user. In an embodiment of the invention, the member must activate their account (e.g., by clicking the link in the email) within 30 days of registration. Otherwise, the SNS-LSS website may remove the user's information from its database.

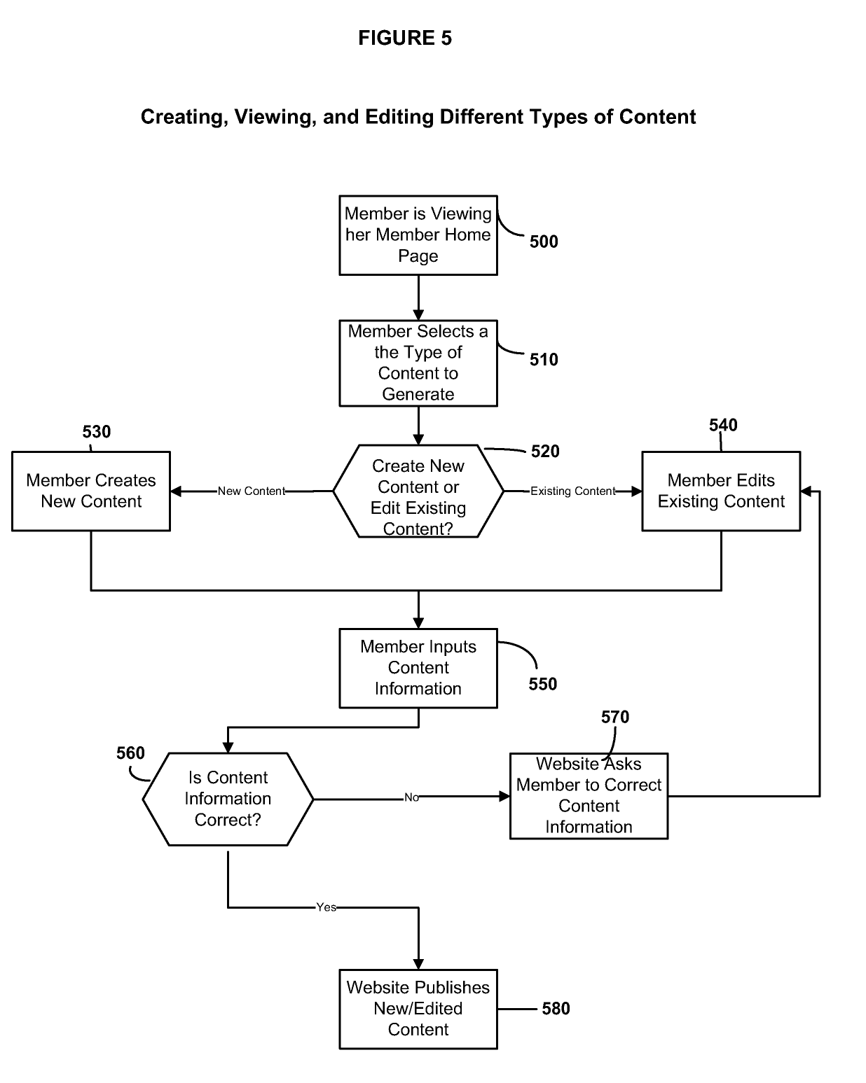

Once a member is registered and is assigned a Member Home Page (See FIG. 6), they can generate their own content. FIG. 5 is a flow diagram illustrating a method for a member to generate different types of content in accordance with an embodiment of the invention. First, to generate content the member must be viewing her Member Home Page in an embodiment of the invention as shown at stage 500. Next, the member selects a type of content to generate at stage 510. Some examples of different types of content include uploading photographs and sharing them with fellow members, creating Places, Communities, and Events (further details of these types of content will be provided in description of later figures), and posting messages, comments, reviews, and blogs. In other embodiments, the content can include music and video content. Next, a member can decide to create new content or edit existing content (e.g., as illustrated at stages 520, 530, and 540). Once the member decides whether to create or edit content, they may input the content information using the software tools provided by the SNS-LSS website at stage 550. At stage 560, the website validates the information. If the website finds an error in the entering of the information, it asks the member to correct it by editing the information at stage 570. A common error may include members incorrectly typing names of photograph files when uploading them to the SNS-LSS website. However, after the website validates the content information, it publishes the new or edited content onto the website at stage 580.

FIG. 6 is a diagram of an exemplary user interface in accordance with an embodiment of the present invention. Specifically, FIG. 6 is an embodiment of the Member Home Page for an SNS-LSS website. A Member can choose to view and generate several pieces of the user's content by clicking one of several content links (600, 605, 610, 615, 620, and 625). These include viewing the members “Favorites,” “Photos,” “Places,” “Buddies,” “Profile,” and editing the user's profile. In further embodiments of the present invention, the interface may include “Community,” “Event,” “Forum,” “Comment,” “Review,” “Blog,” “Music,”and “Video” content. To understand Place content one must remember that an embodiment of the present invention provides members with a local search service that allows them to find businesses and make them a part of the content of their member web space. This type of content is referred to as a Place in this embodiment of the invention. Thus, a Place is a type of content that contains information of a local business. For example, a Place may contain information related to a local restaurant, listing the address and type of cuisine (e.g. a Roma Restaurant offering Italian food).

Once a member creates a Place on his or her web space, they can share it with fellow members. A Place may have several other pieces of content associated with it including Forum, Photo Album, Blog, Comment and Review. Furthermore, if the member is the business owner of the Place, she can provide more content about the Place using the website's software tools. However, the website provides a validation process to authenticate a business owner to a Place. This validation process is an administrative function that prevents market saboteurs from providing misinformation. By providing more features for business owners and a validation process, embodiments of the present information provide incentives for a business member to create and maintain business content on the website. Business owner features may include editing business information, soliciting other business owners as potential customers or suppliers, and selling merchandise to fellow members and visitors.

In addition to generating Place content, a member can generate several other types of content within their web space on the SNS-LSS website. Photos 605 are simply photographic content that a member can upload, e.g., from their personal computer, and organize into albums on the member's web space. Favorites 600 are catalog of Places saved by a member to easily find for future use. Buddies 615 are another type of content that provide contact lists of fellow members cataloged by members for future use. Profile (620, 625) information provides the published personal information of a member. Comments and Blogs comprise messages that members post to Places, Communities, Forums, and Events. Reviews are messages by fellow members complimenting or criticizing a business associated with a Place. A Forum is a collection of Blogs by members associated with a Place, Community, or Event.

Communities are a type of content created by a member to allow fellow members to join and create Photo Albums and Blogs on any one topic. Communities are organized by topic according to a main category and a subcategory. Alternatively, Events are content generated by a business owner to associate with the user's Place. For example, if a restaurant owner of a Place intends to have a special New Year's Eve dinner for customers, then the restaurant owner may generate an Event on the SNS-LSS website and publish it to her fellow members and visitors. Fellow members can Blog in an Events Forum to provide comments, critiques, or compliments about the Event. Finally, a further embodiment allows a member to upload music or video content onto their web space similar to uploading photographic content. If a member chooses to generate photograph content for their member web space, the user may click on the “My Photos” link 605.

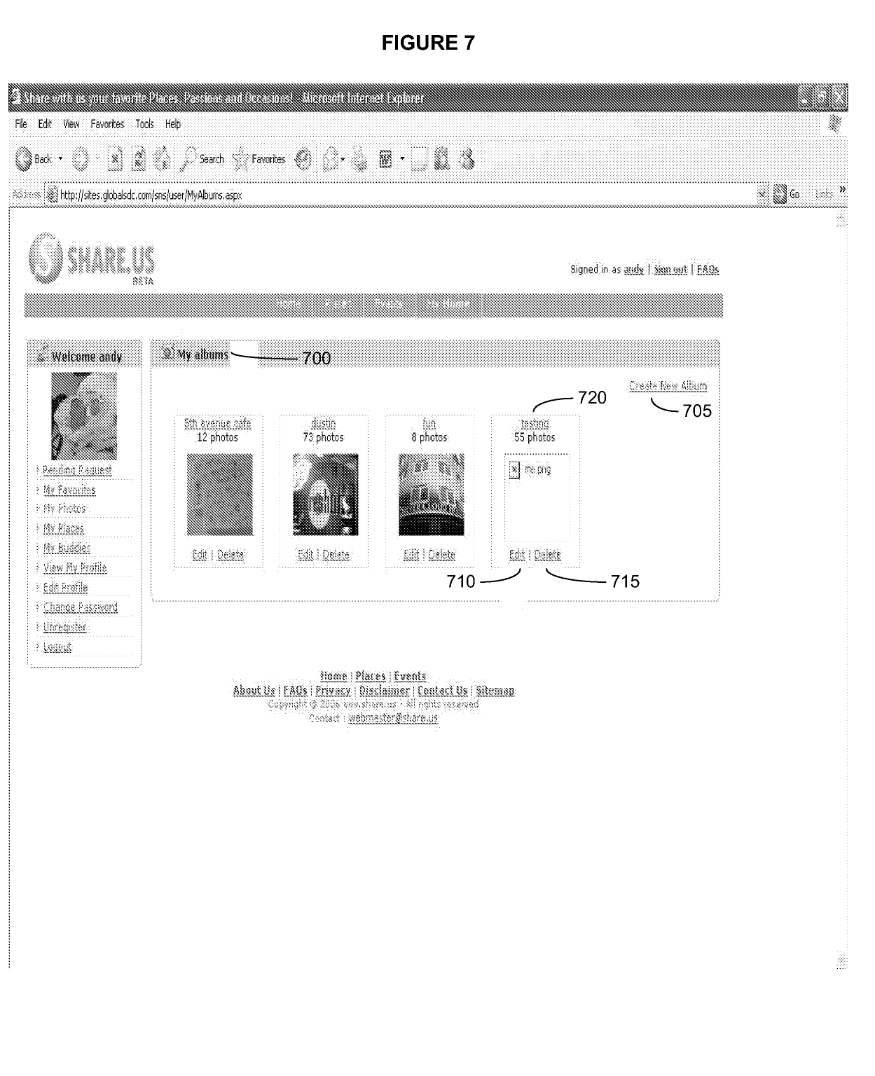

FIG. 7 is a diagram of an exemplary user interface for allowing a member to generate photographic content within an embodiment of the invention. In particular, FIG. 7 displays a Member Photo Album Home Page. This page displays all the photo albums that the member has created and shared with fellow members and visitors of the SNS-LSS website 700. This embodiment of the invention also allows the member to create a new photo album 705 as well as edit 710 and delete 715 existing photo albums.

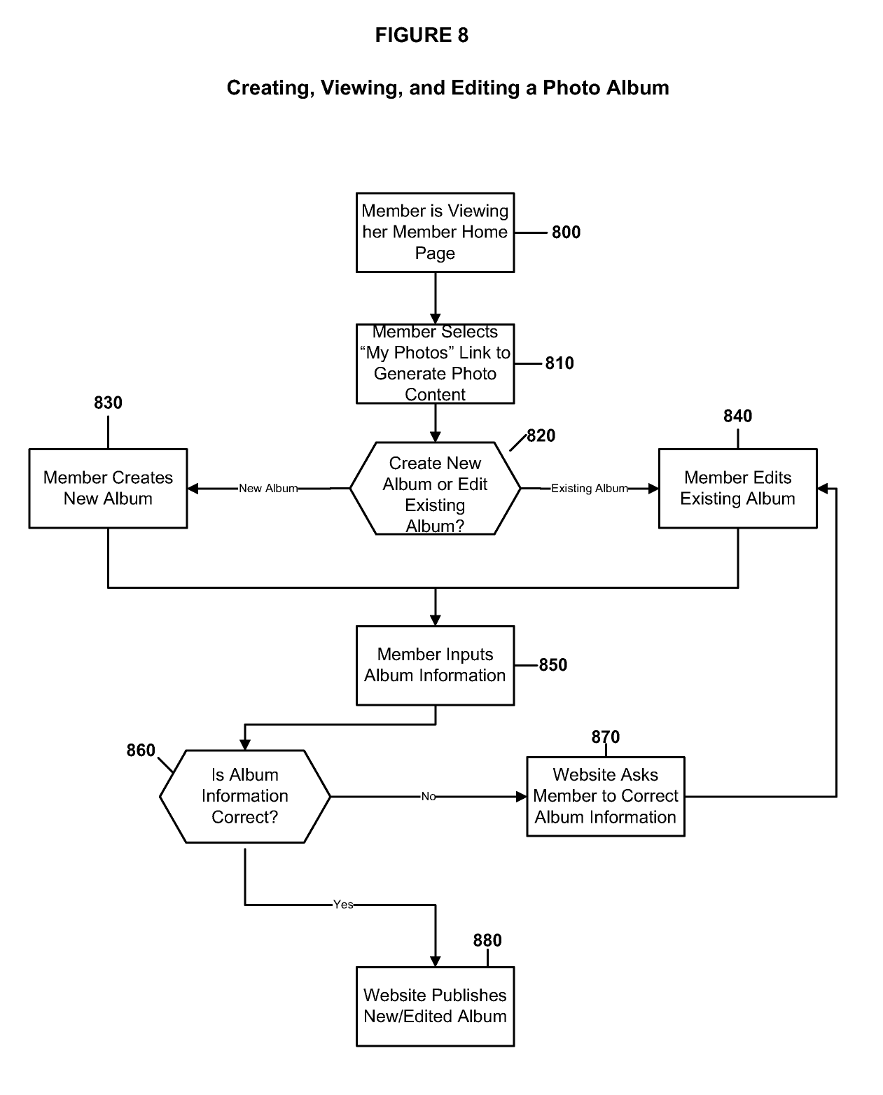

FIG. 8 is a flow diagram illustrating a process allowing a member to generate photo album content in accordance with an embodiment of the invention. The flow diagram of FIG. 8 is similar to the one shown in FIG. 5, except that FIG. 8 pertains specifically to an embodiment for generating photographic content. Referring to FIG. 8, the member first views their Home Page at stage 800 then clicks on the “My Photos” link 605 to begin generating new photographic content at stage 810. A member can create a new photo album or edit an existing photo album as shown at stages 820, 830, and 840. Once the user decides whether to create or edit content, the they input the album information using the web and software tools provided by the SNS-LSS website at stage 850. Next, the website (e.g., the software supporting the website) validates the information at stage 860. If the website finds an error in the entering of the photo album information, it asks the member to correct it by editing the information at stage 870. A common error may include members incorrectly typing names of photograph files when uploading them to the SNS-LSS website. However, if the website validates the content information, it publishes the new or edited photo album onto the website at stage 880.

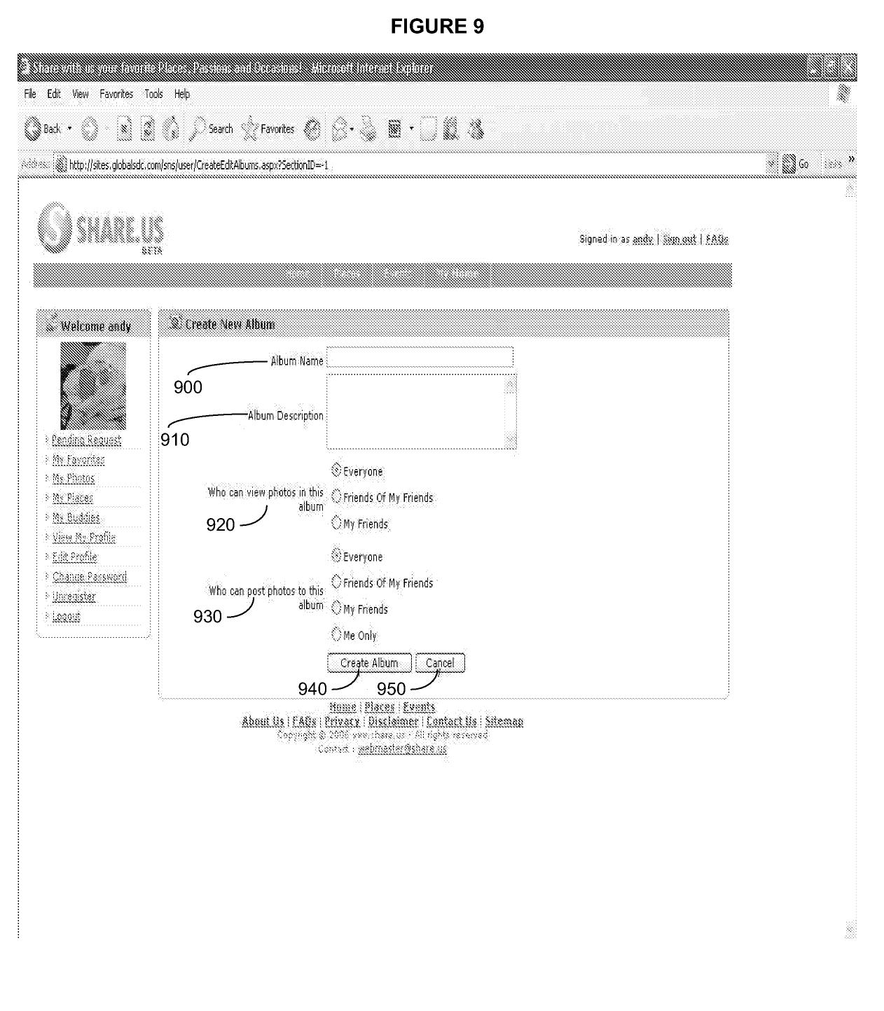

FIG. 9 is a diagram of an exemplary user interface for allowing a member to generate photographic content according to an embodiment of the present invention. Specifically, FIG. 9 is a screen shot of the Create Album Web Page after clicking the “Create Album” Link 705 in the Member Photo Album Home Page (See FIG. 7). A member may enter several pieces of album information to create an album. This includes entering an album name 900 and an album description 910. In addition, the member may set permissions determine who can view 920 or post photos to the album 930. Lastly, the member can click on the “Create Album” push button 940 to create the album or cancel from creating an album 950.

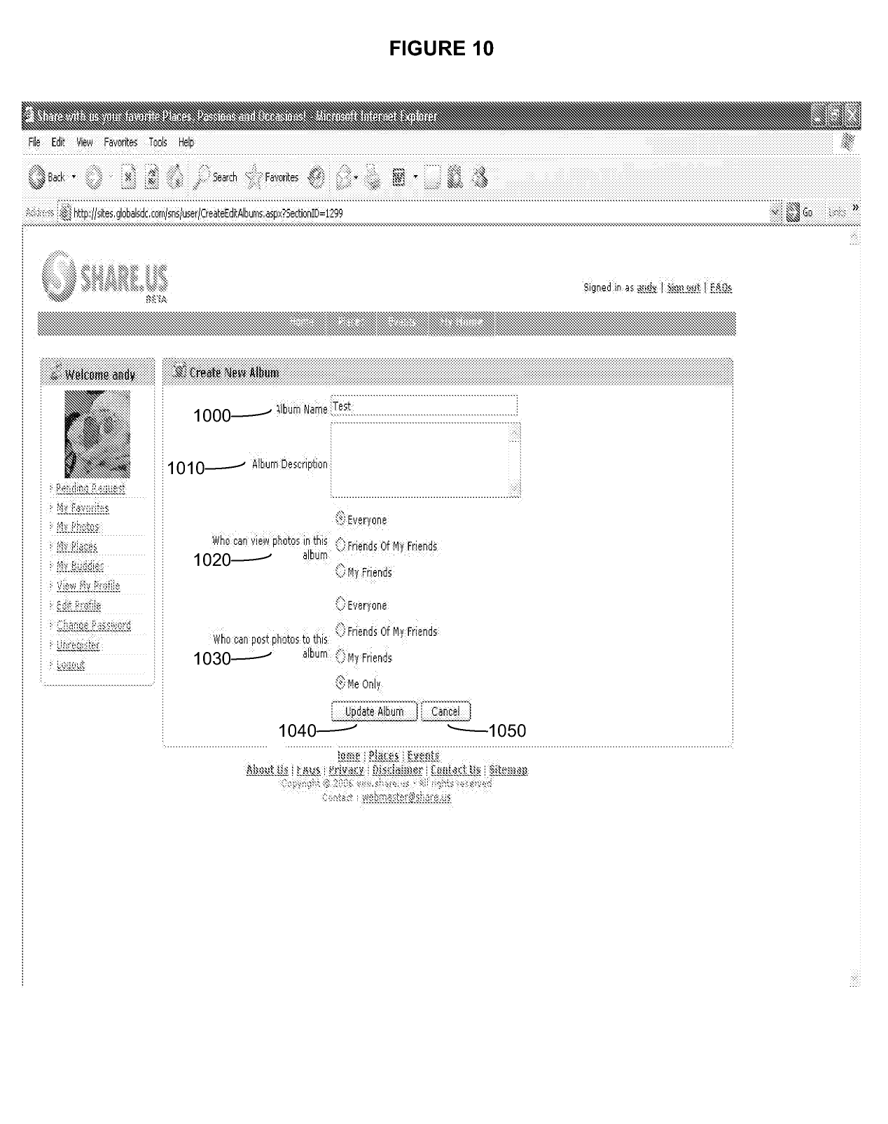

FIG. 10 is a diagram of an exemplary user interface for allowing a member to edit photographic content according to an embodiment of the invention. Similar to FIG. 9, FIG. 10 displays an Edit Existing Album Web Page after a user selecting the “Edit” Link 710 under an album on the Member Photo Album Home Page (See FIG. 7). A member may enter several pieces of album information when editing an album. This includes editing an album name 1000, and an album description 1010. In addition, the member may edit permissions to determine what members can view 1020 or post photos to the album 1030. Lastly, the member can click on the “Update Album” push button 1040 to update the modifications to the album or cancel from editing the album 1050.

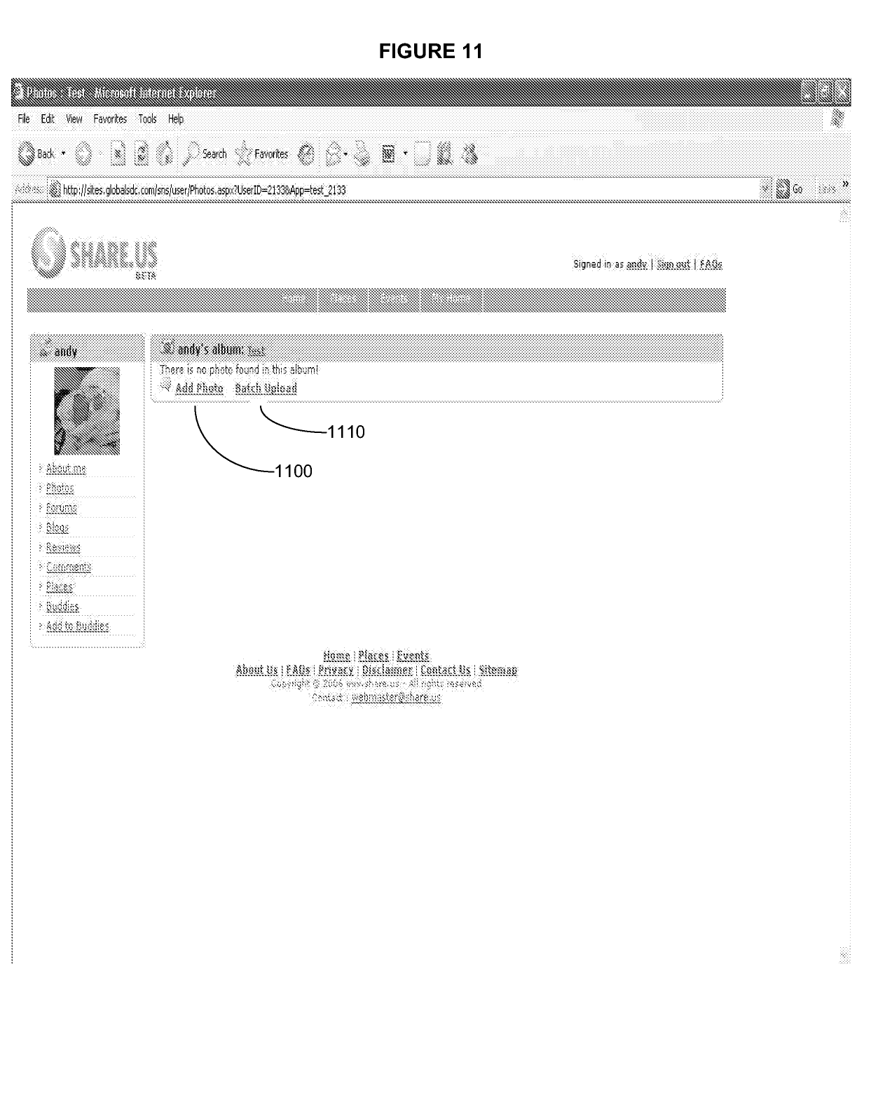

FIG. 11 is a diagram of an exemplary user interface for allowing a member to add photographic content according to an embodiment of the present invention. Once an album is created, a member can upload photographs to the album. When the member clicks on the name of the album 720 on the Member Photo Album Home Page (See FIG. 7), the site displays the Photo Web page (See FIG. 11). The member can upload photographs, one at a time, by using the “Add Photos” link 1100, or can upload several photographs at once by clicking the “Batch Upload” link 1110.

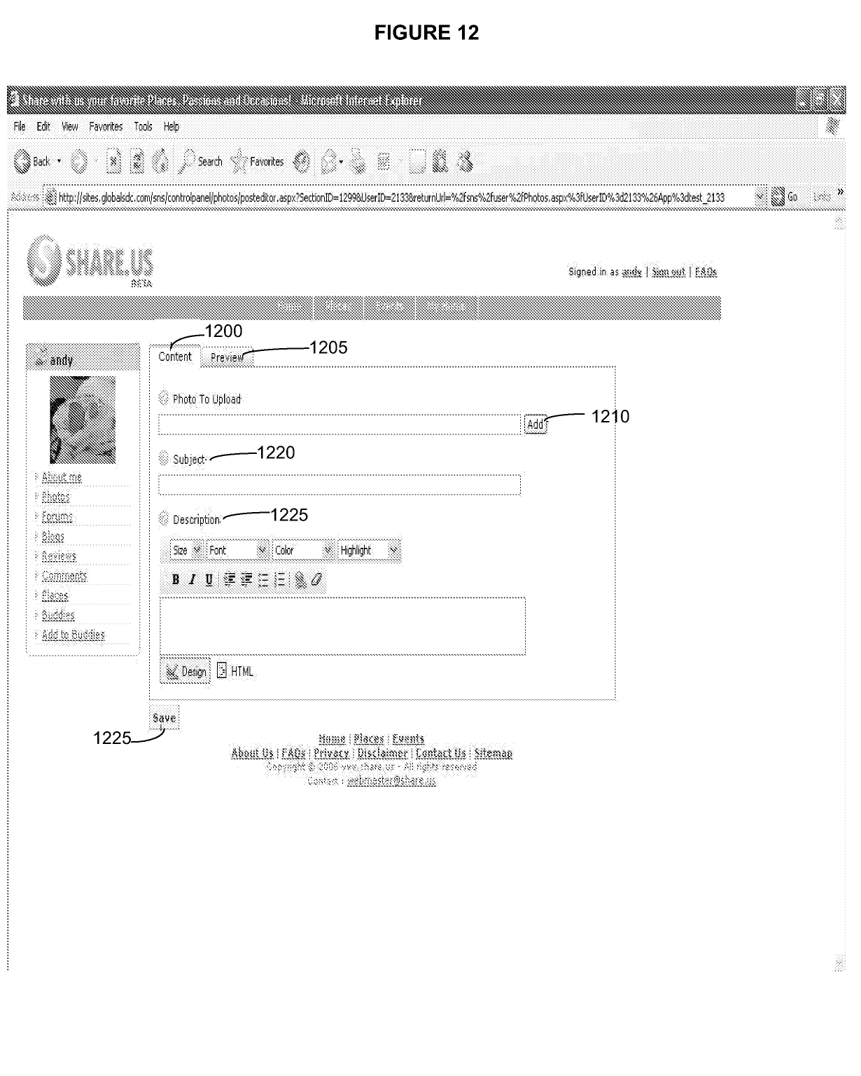

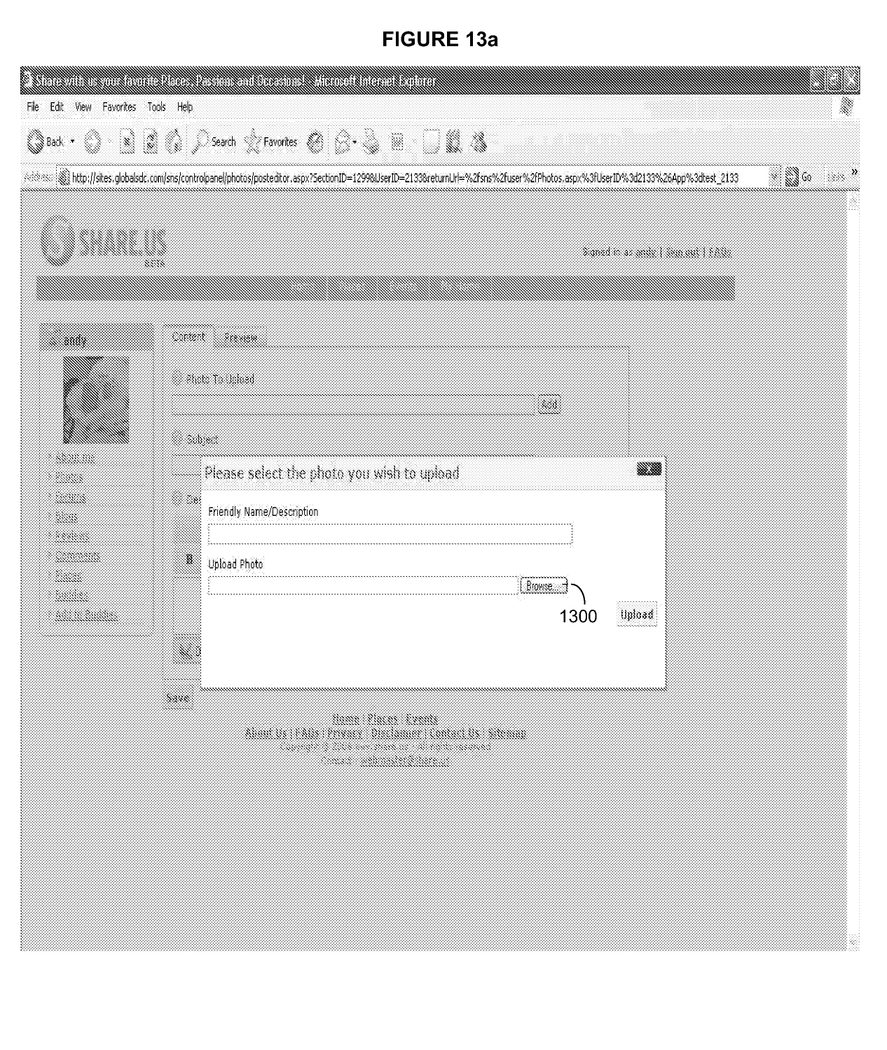

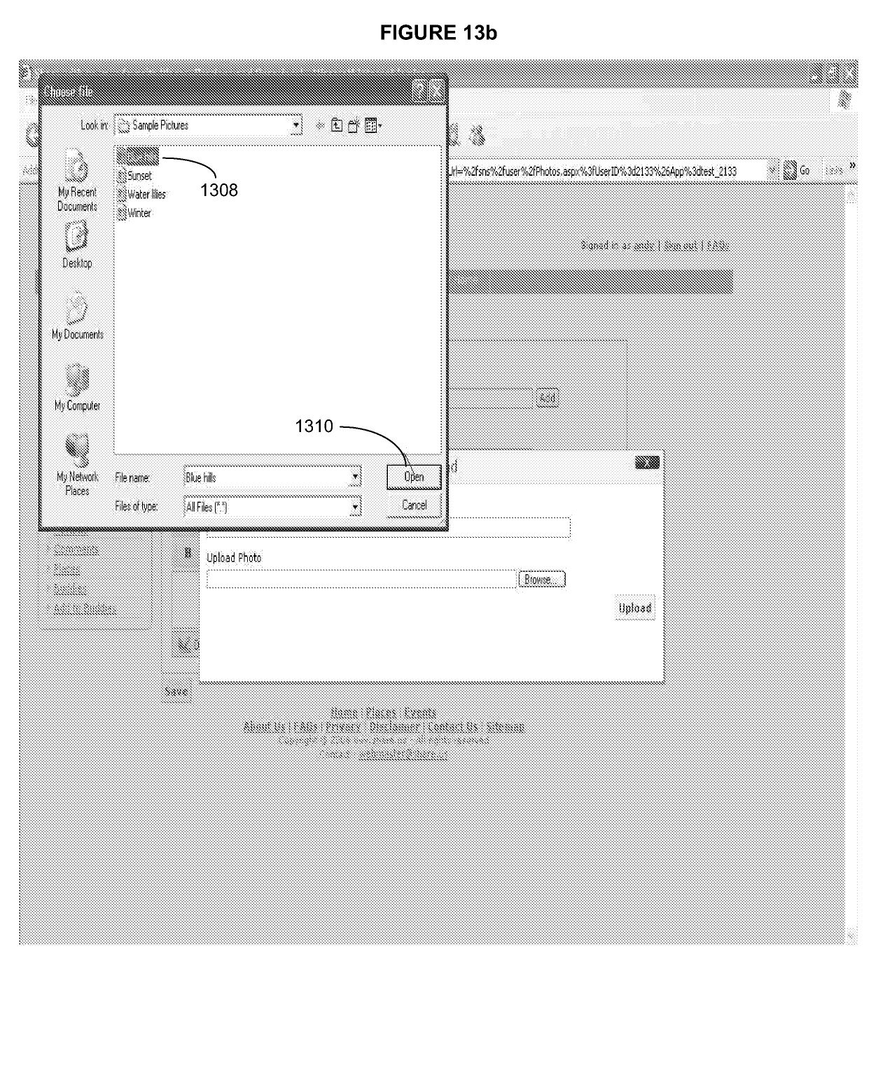

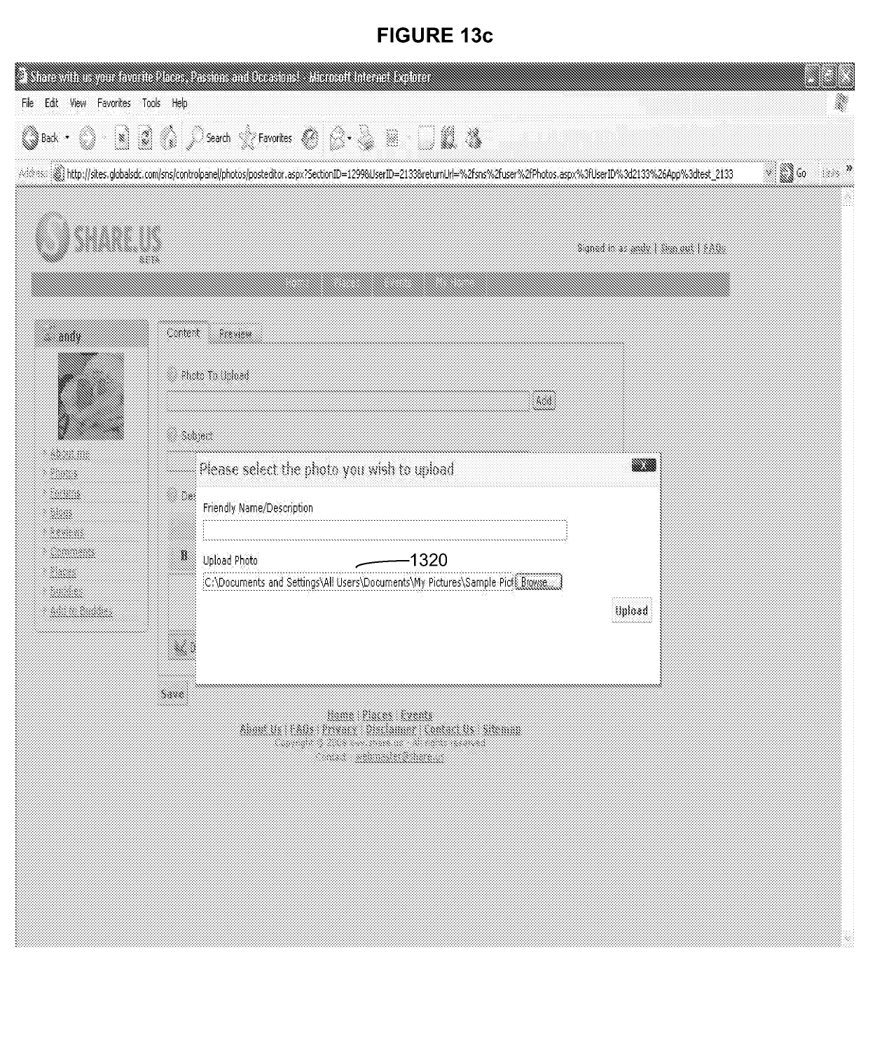

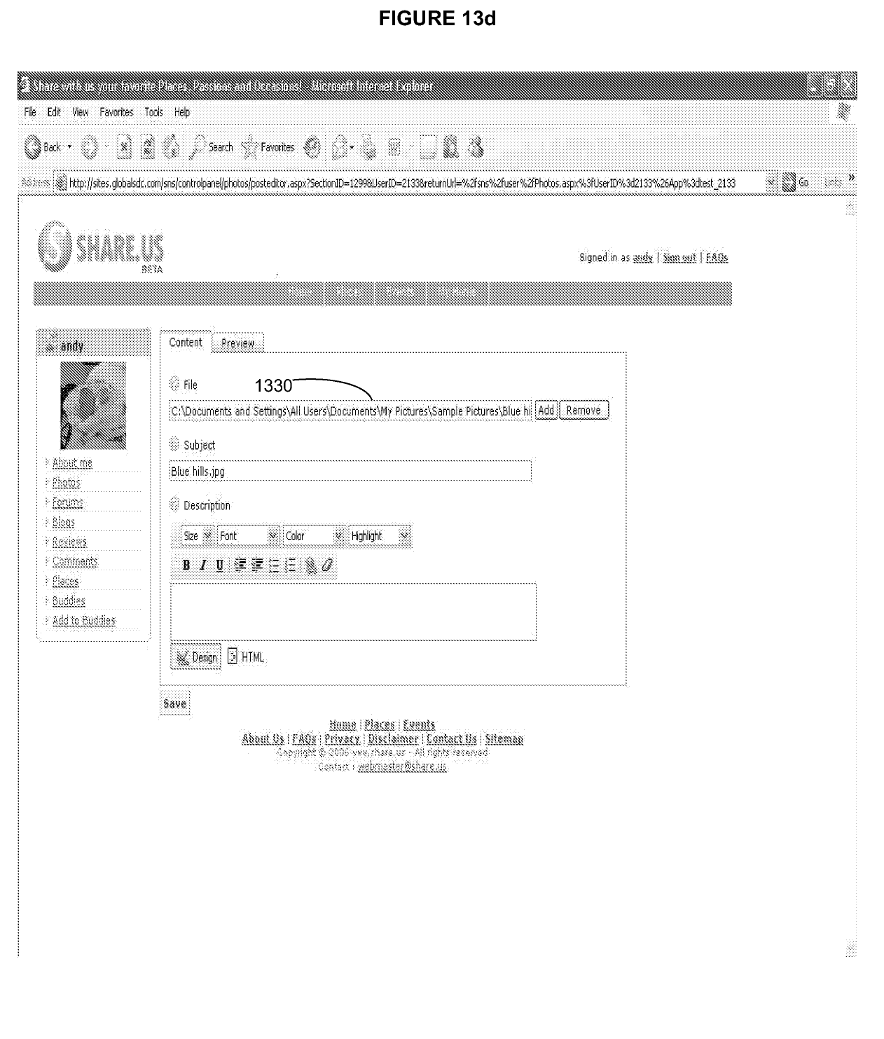

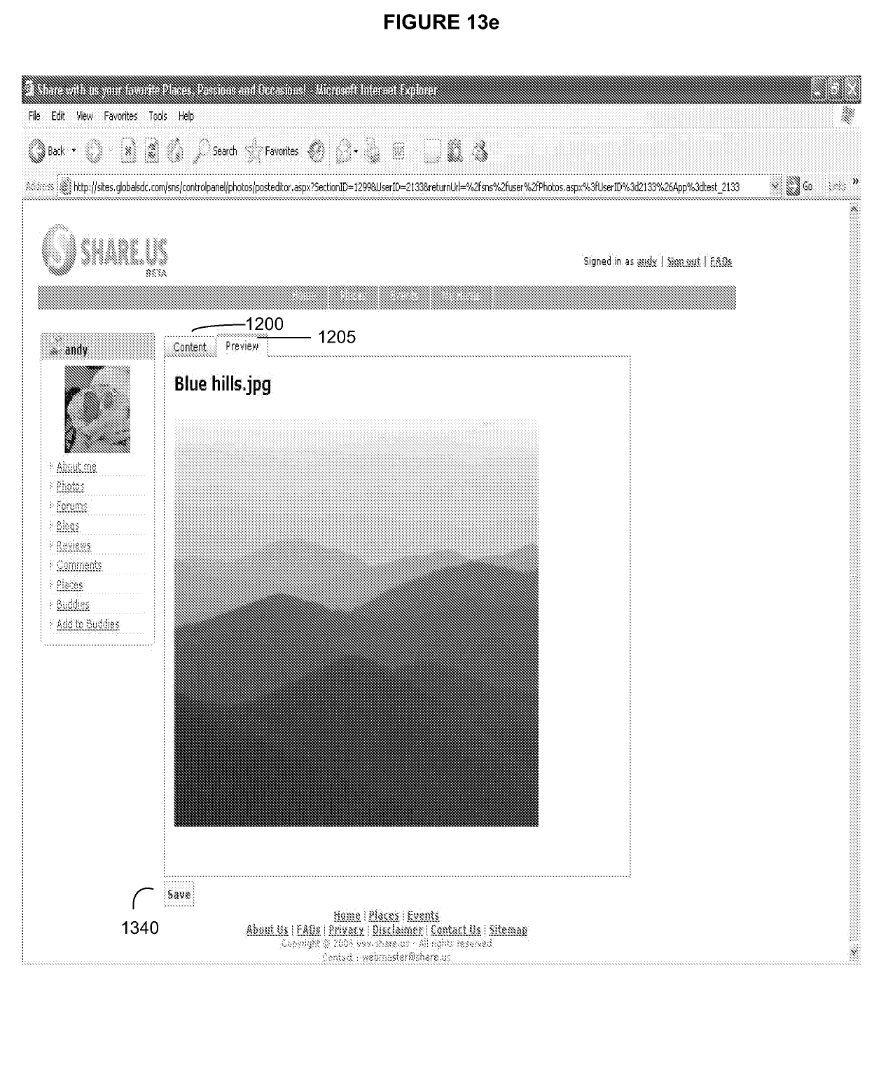

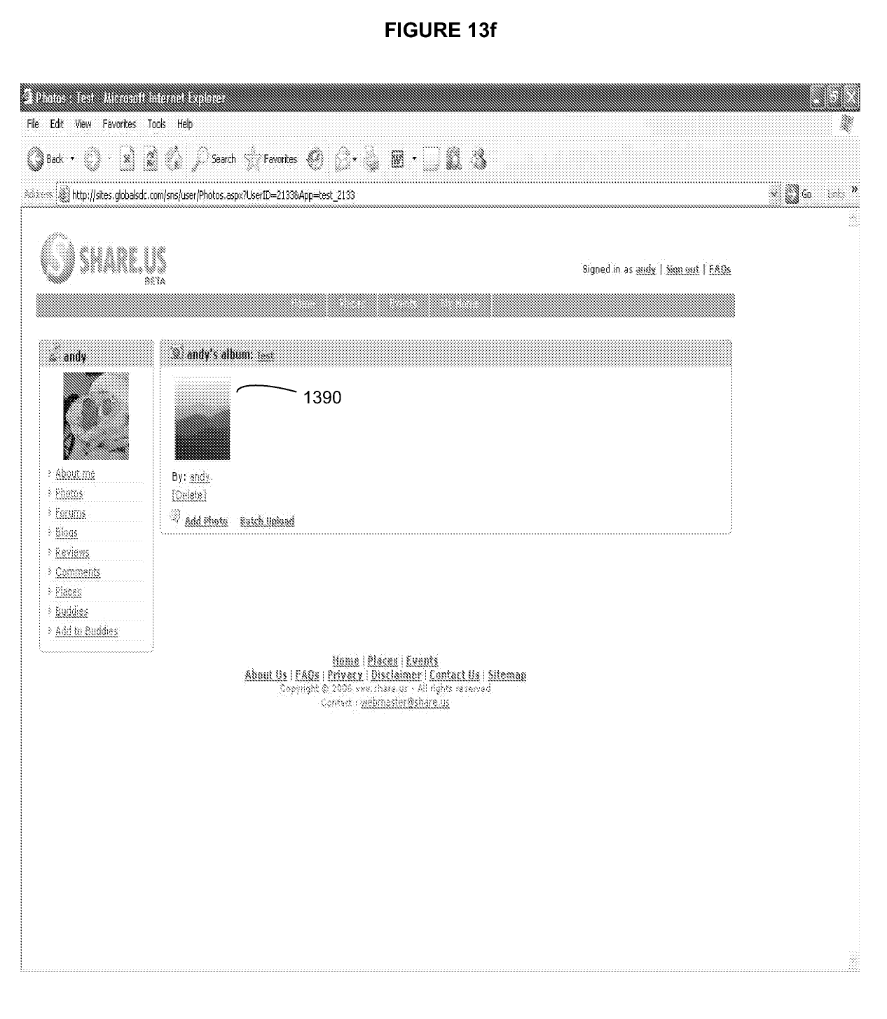

FIG. 12 is a diagram of an exemplary user interface allowing a member to add photographic content, one photograph at a time, according to an embodiment of the invention. After clicking the “Add Photos” link, the member views the Add Photos Web Page as shown in FIG. 12. By clicking the “Add” push button 1210 within the “Content” tab 1200, the member can select a photograph from her computer to upload to the website (See FIG. 13a).

FIGS. 13a-13f are diagrams of exemplary user interfaces for allowing a member to add photographic content, one photograph at a time, according to an embodiment of the invention. In FIG. 13a, the member can select the “Browse” push button 1300 to select a photograph from the user's computer to upload to the website as shown in FIG. 13b. In FIG. 13b, a member can select a photograph from a directory 1308 from the user's computer. Once the member selects a photograph to upload, they select the “Open” push button 1310. Next, in FIG. 13c, the photo is ready to be uploaded to the website 1320. FIG. 13d shows the photo displayed on the website 1330. Clicking on the “Preview” tab 1205 (See FIG. 12) displays the photograph, as it would be seen on the website, as shown in FIG. 13e. Clicking on the “Save” push button 1340 saves the photograph into the album as shown in FIG. 13f.

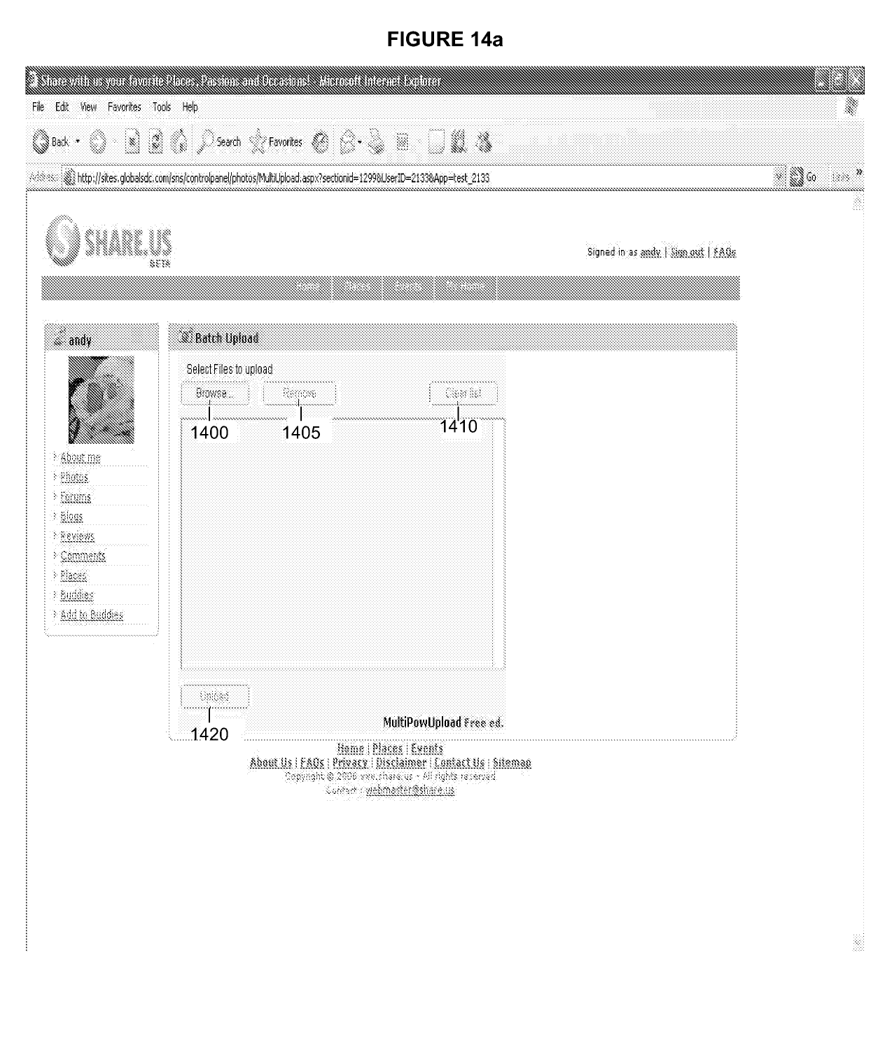

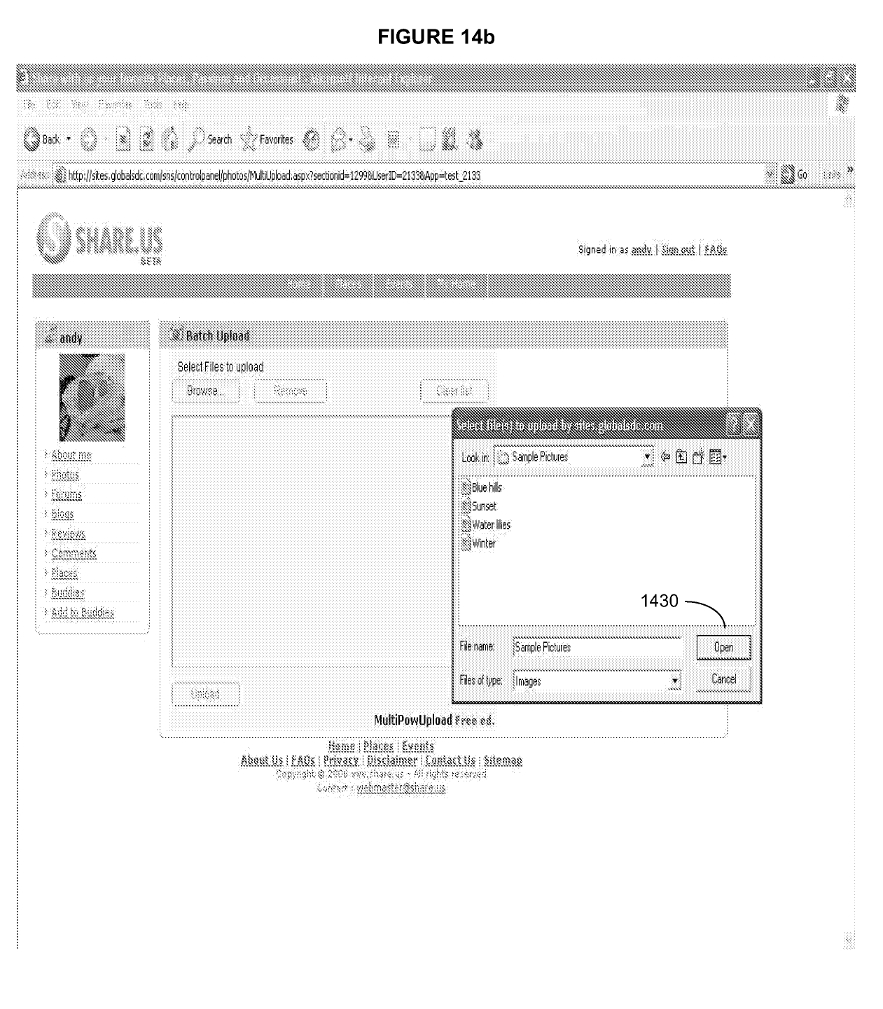

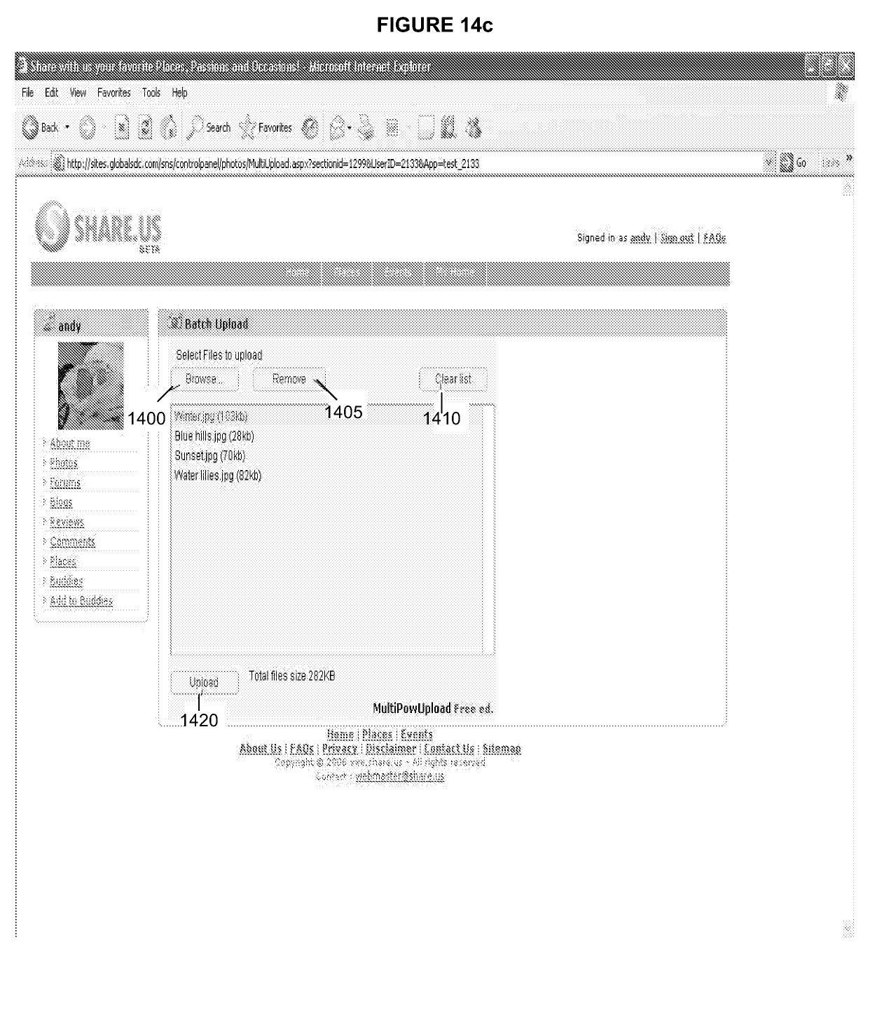

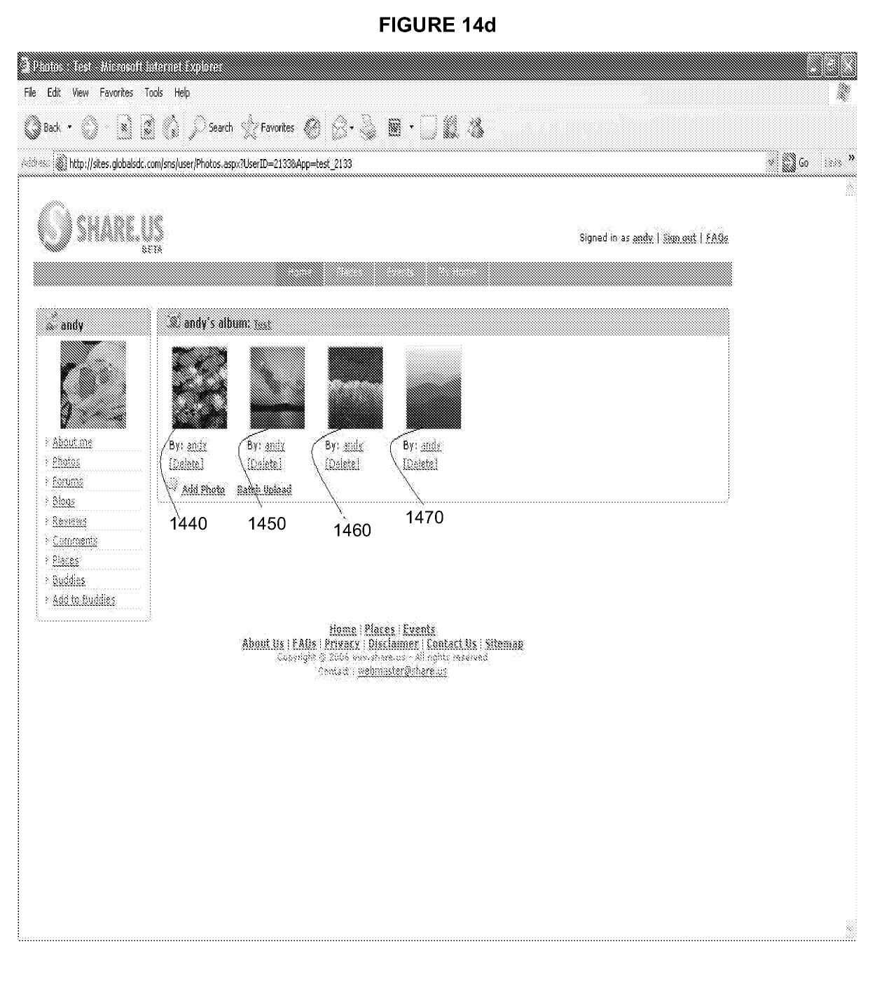

Similar to FIGS. 13a-13f, FIGS. 14a-14d are diagrams of exemplary user interfaces for allowing a member to add photographic content, several photographs at a time, according to an embodiment of the present invention. Specifically, by clicking the “Batch Upload” link the member views the Batch Upload Web page as shown in FIG. 14a. The member clicks on the “Browse” push button to select several photographs into an album to upload 1400. In FIG. 14b, a member can select several photographs from a directory on her computer. Once the member selects the photographs to upload, the user may click on the “Open” push button 1430. Next, the website lists the photographs to be uploaded in the Batch Upload Web page as shown in FIG. 14c. From this web page, the member has several web tools available to modify the uploading of photographs. The user can remove a single photograph from the list 1405. Conversely, they can remove all the photographs from the list by clicking the “Clear List” push button 1410. Lastly, the user can upload the selected photographs by clicking on the “Upload” push button 1420. The album will contain the batch uploaded photographs as shown in FIG. 14d (1440, 1450, 1460, and 1470).

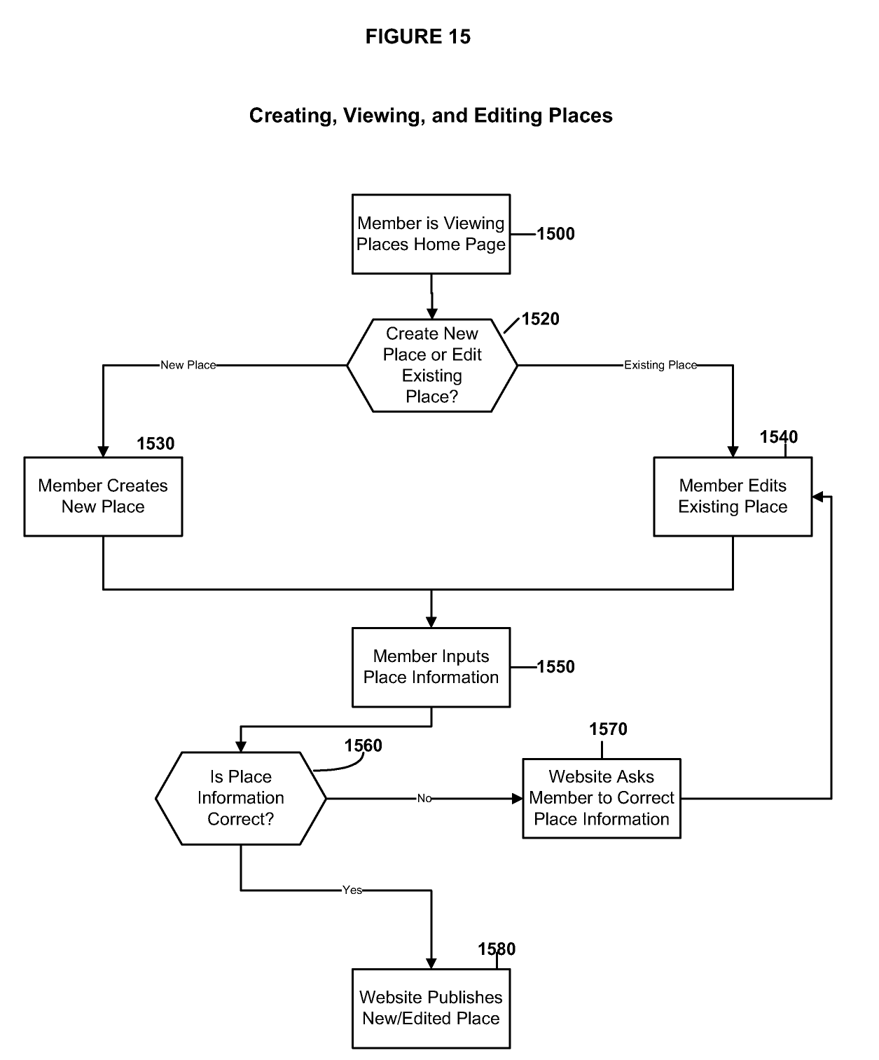

FIG. 15 is a flow diagram illustrating a method for allowing a member to generate business content in accordance with an embodiment of the invention. First, the member views the Places Home Page 1500. A member can create a new Place or edit an existing Place (1520, 1530, and 1540). After deciding whether to create or edit a Place, the member inputs the Place information using the software tools provided by the SNS-LSS website 1550. Next, the website validates the information 1560. If the website finds an error in the Place information, it asks the member to correct it by editing the information 1570. Common errors may include for example incorrectly typed names and addresses of the Places. Once the website validates the content information, it publishes the new or edited place on the website 1580.

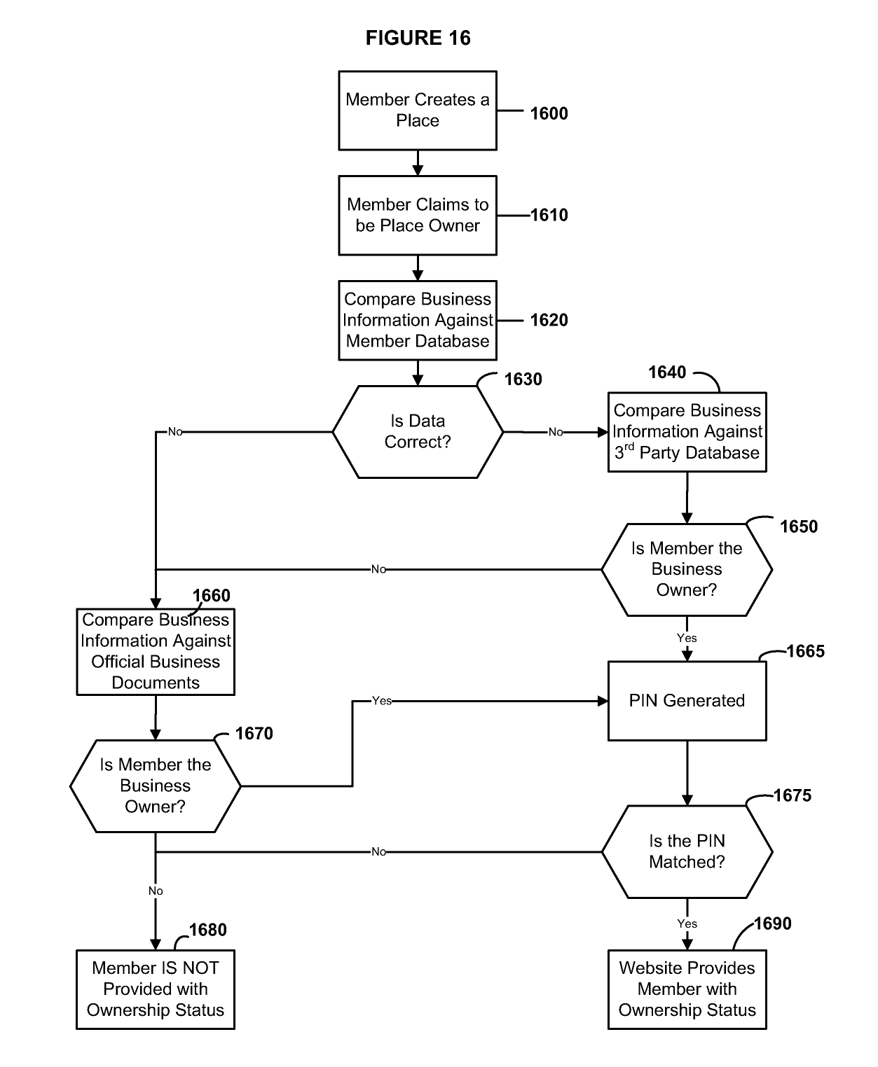

FIG. 16 is a flow diagram illustrating the validation of business ownership status in accordance with an embodiment of the invention. First, a member creates a Place on the SNS-LSS website at stage 1600. Next, the member represents himself or herself as the owner or agent of the business associated with the created Place at stage 1610 by providing the appropriate member/business data (See FIG. 4a). Next, the website will validate whether the member is the business owner or agent by comparing the member business information against the business information contained in its database at stage 1620. The data provided by the member is a pre-screen stage 1610. Once it is verified 1630 (i.e. the member is the business owner according to the information contained in the member database) at stage 1630, then the website will compare the member business information against a third party business information database at stage 1640. Further verification is needed because the member data provided at stage 1610 (See FIG. 4a) is not enough information to confer business ownership status. However, using this data with information from a third party database, the website can verify ownership status 1640. If it determines that the member is not the business owner at stage 1650, then the website will compare the business information against the business's official documents at stages 1660 and 1670. If the website determines that the member is not the business owner after comparing the member's information against official business documents, then the member is not designated with ownership status at stage 1680. However, if at any time the website validates that the member is the business owner of the place, then the website will generate and mail the member a personal identification number (PIN) to her physical address 1665. Subsequently the member must log into the website and enter her PIN to garner ownership status of the Place during her login session 1675. Once the PIN is matched, the member is designated with ownership status at stage 1690 and can utilize the owner features of the SNS-LSS website. These include creating Events for the Place, editing business information, soliciting other business owners as potential customers or suppliers, and selling merchandise to fellow members and visitors.

The website and third party business information database contain information usable to authenticate a member as a business owner in an embodiment of the invention. This information includes a category and subcategory of the business (e.g. Restaurants and Italian Restaurants). In addition, the database may include the address and location (e.g., latitude and longitude) of the business to facilitate the use of the website's mapping tools. In addition to the business address, the database may include other contact information such as email, company website, phone, and fax. These databases may include government and census codes such as FIPS, MSA and PMSA. Finally, the database may include copies of other official business documents such as business licenses and certifications that are filed with state government agencies. Any of the described databases, e.g., the website's own database and/or a third party database, may be in any suitable format including but not limited to Microsoft Excel, Microsoft Access, MySQL, and CSV. All or a subset of the information contained in the database may be used during the validating of business content. The present invention is not limited to validating business content but may validate any content generated by members.

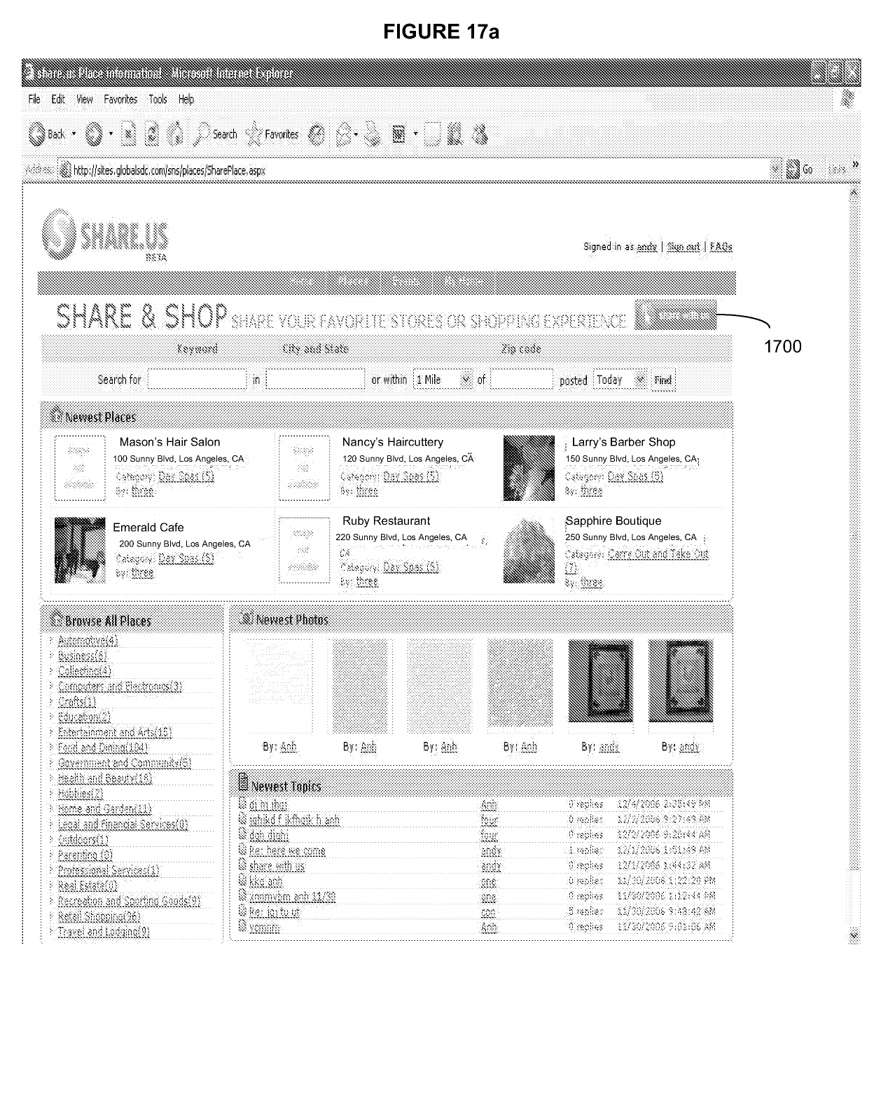

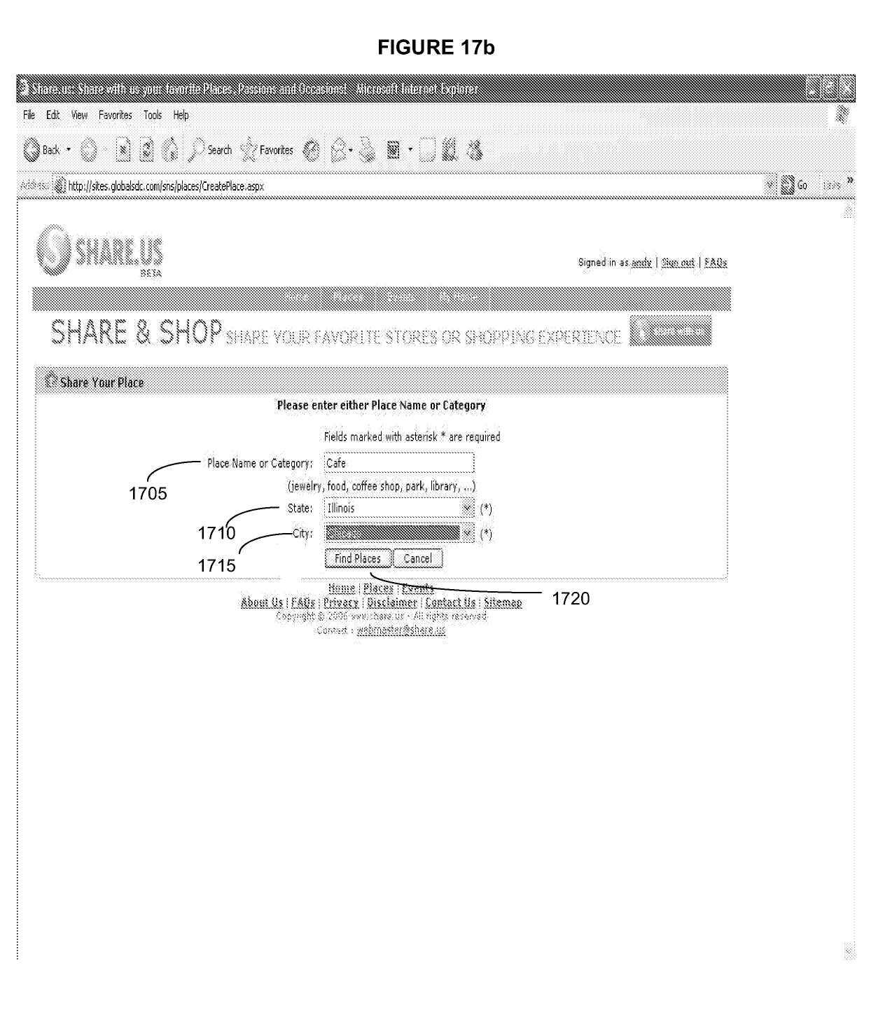

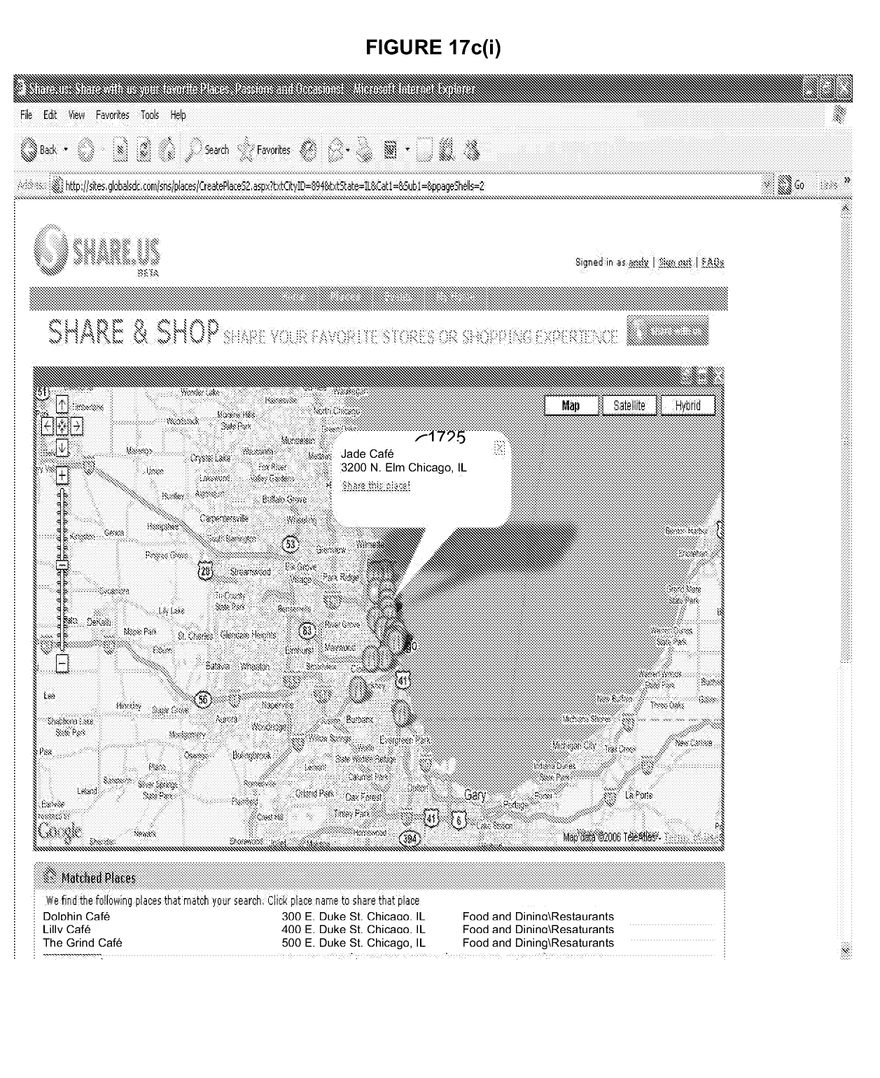

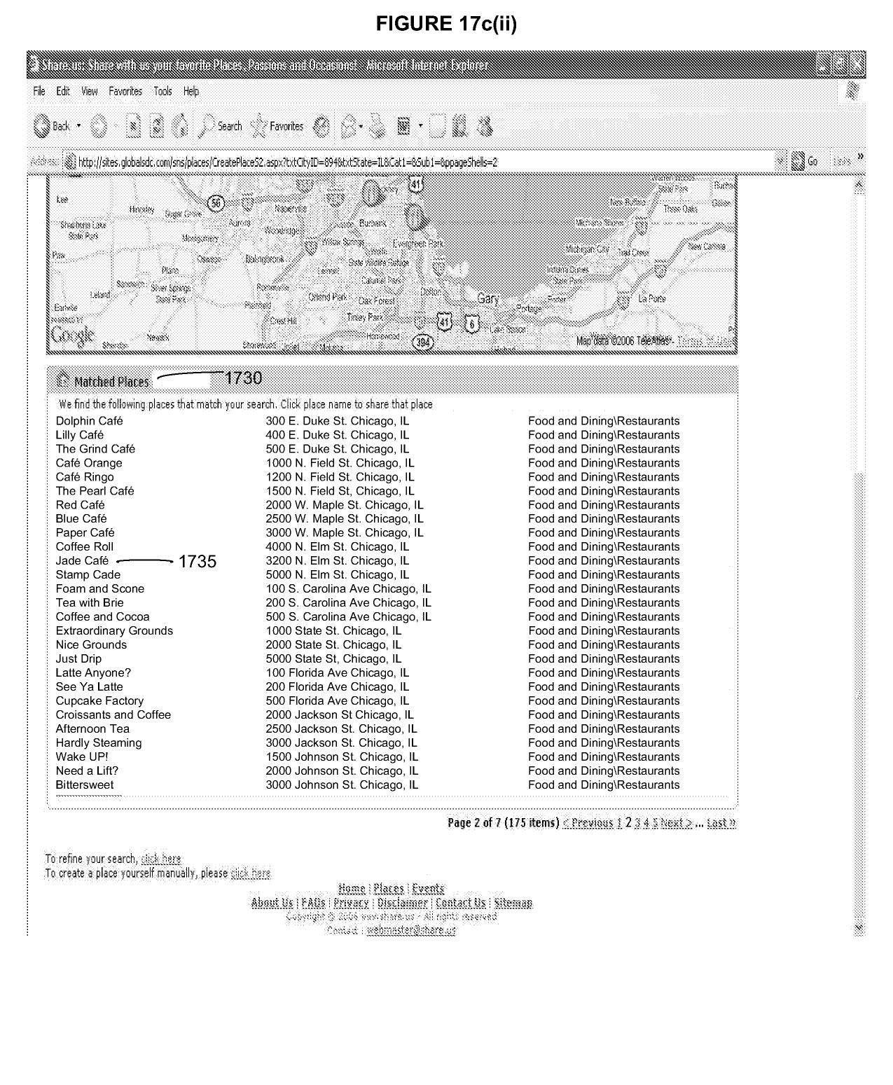

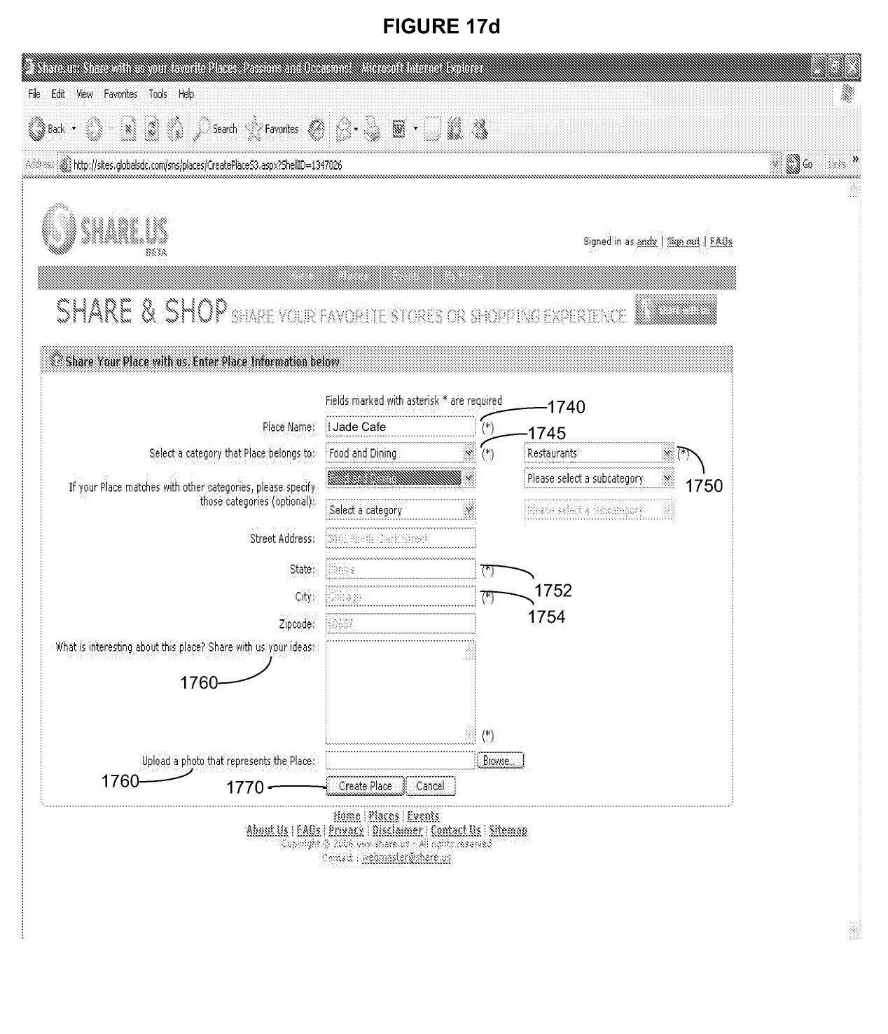

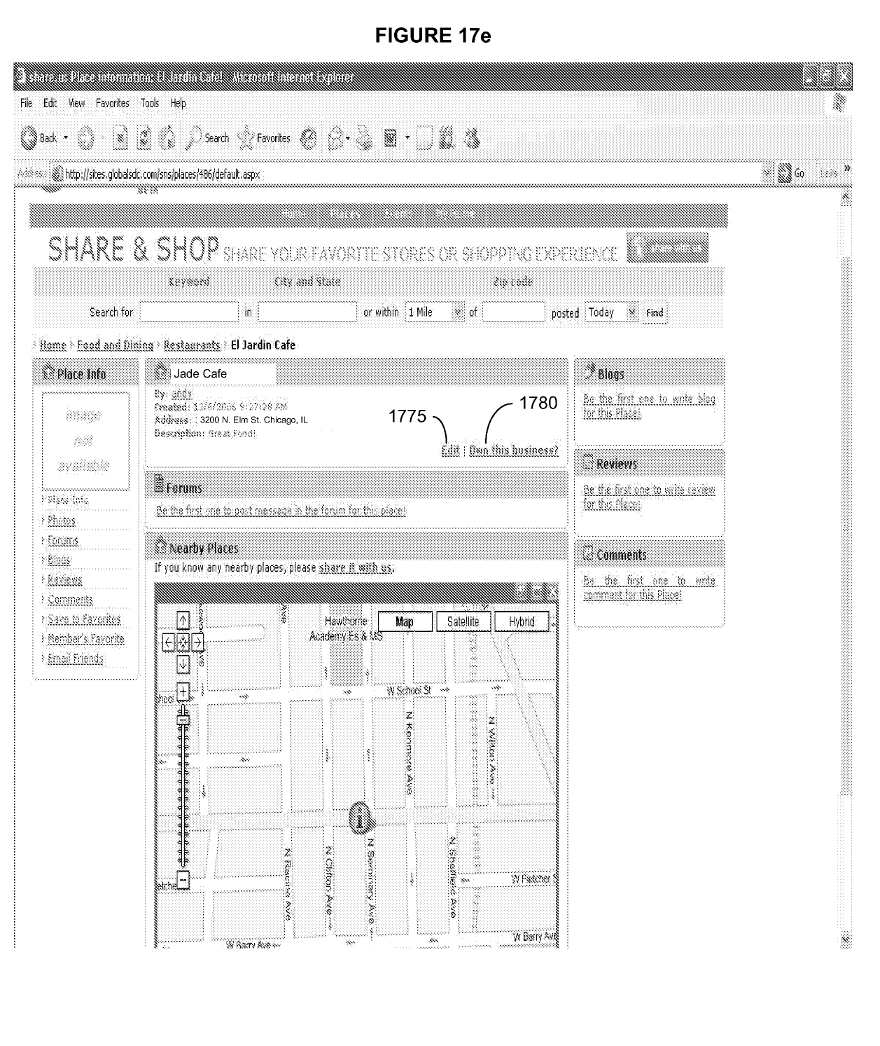

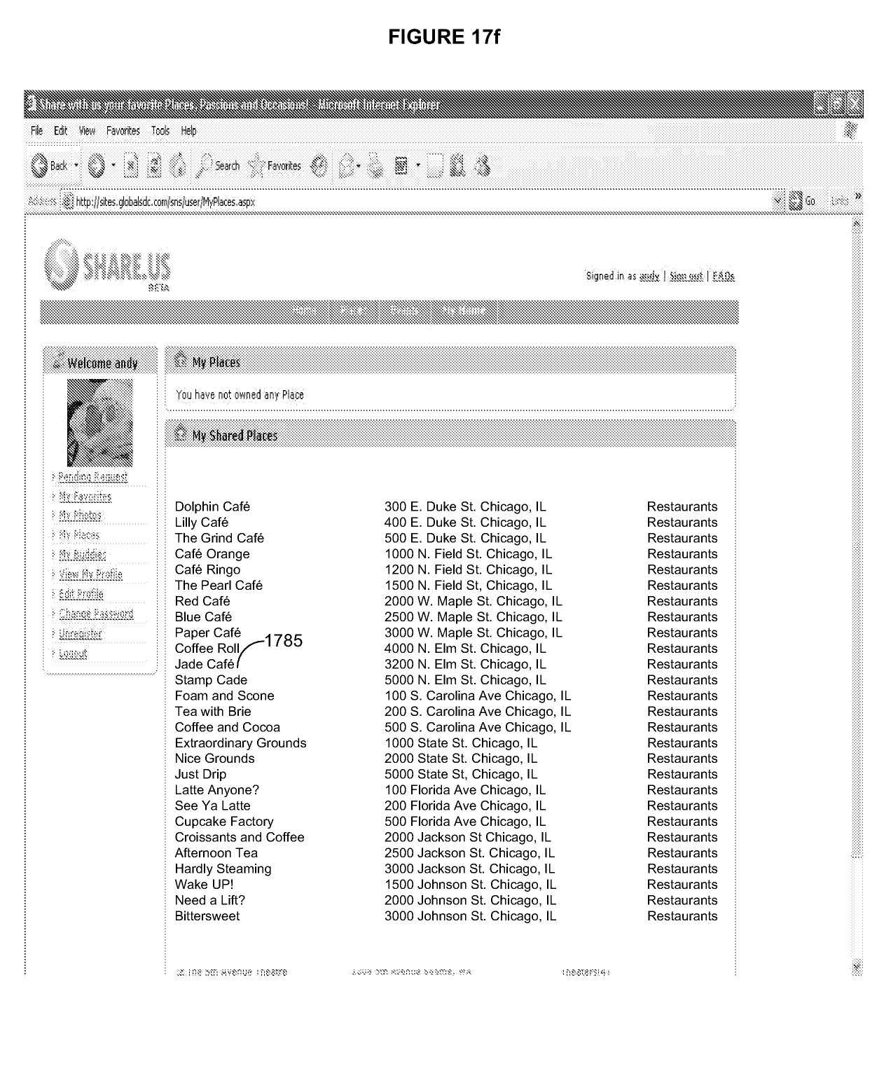

FIGS. 17a-f are diagrams of exemplary user interfaces for allowing a member to view, create, or edit business content, in an embodiment of the invention. Specifically, FIGS. 17a-17f are a series of screen shots that show the creation of a new Place. FIG. 17a shows the Places Home Page. In order to create a Place, a member may click on the “share with us” 1700 push button. This leads the member to view the Share Your Place Web Page shown in FIG. 17b. A member enters Place information that may include Place name or category 1705, state and city (1710, 1715). After entering the Place information, a member may click the “Find Places” push button 1720. Selecting the “Find Places” 1720 push button leads a member to view the Map Place Web Page (See FIGS. 17c(i) and 17c(ii)). FIG. 17c(i) shows the top portion of the page, while FIG. 17c(ii) shows the bottom portion of the web page. In FIG. 17c(i) the website indicates the Places from the category she has chosen on the map 1725. Conversely, in FIG. 17c(ii) the website provides a list of the Places from the chosen category 1730. A Member can select one Place among the list of Places (1730, 1735). Clicking on the name of the Place brings the member to the Place Information Web Page as shown in FIG. 17d. On this web page, the member can enter several pieces of Place information including the name of the Place 1740, the category and subcategory of Place (1745,1750), the address of the Place (1752, 1754), a description of the Place 1760, and a photograph of the Place 1765. After entering in this information, the member can click the “Create Place” push button 1770. This action triggers the website to publish the new Place as part of the Places web page (See FIG. 17e) and part of the member's “My Places” (See FIG. 17f) member web space.

A member has the ability to edit Place information by clicking the “Edit” link on the Place Home Page 1775. In another embodiment, a member may want to create a Place manually, by entering the Place's address. Then the SNS-LSS website will query a third party database to validate the address. If the address is not valid, the SNS-LSS website will ask the member to review the address and re-enter the information.

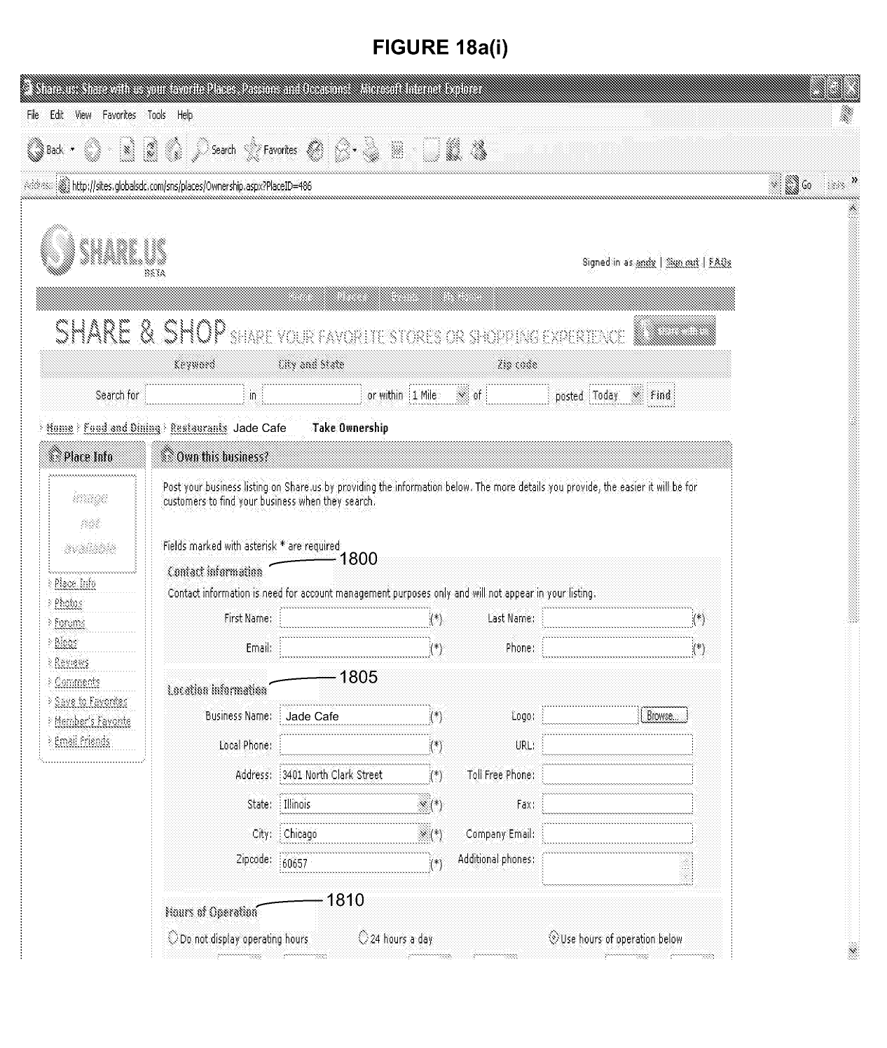

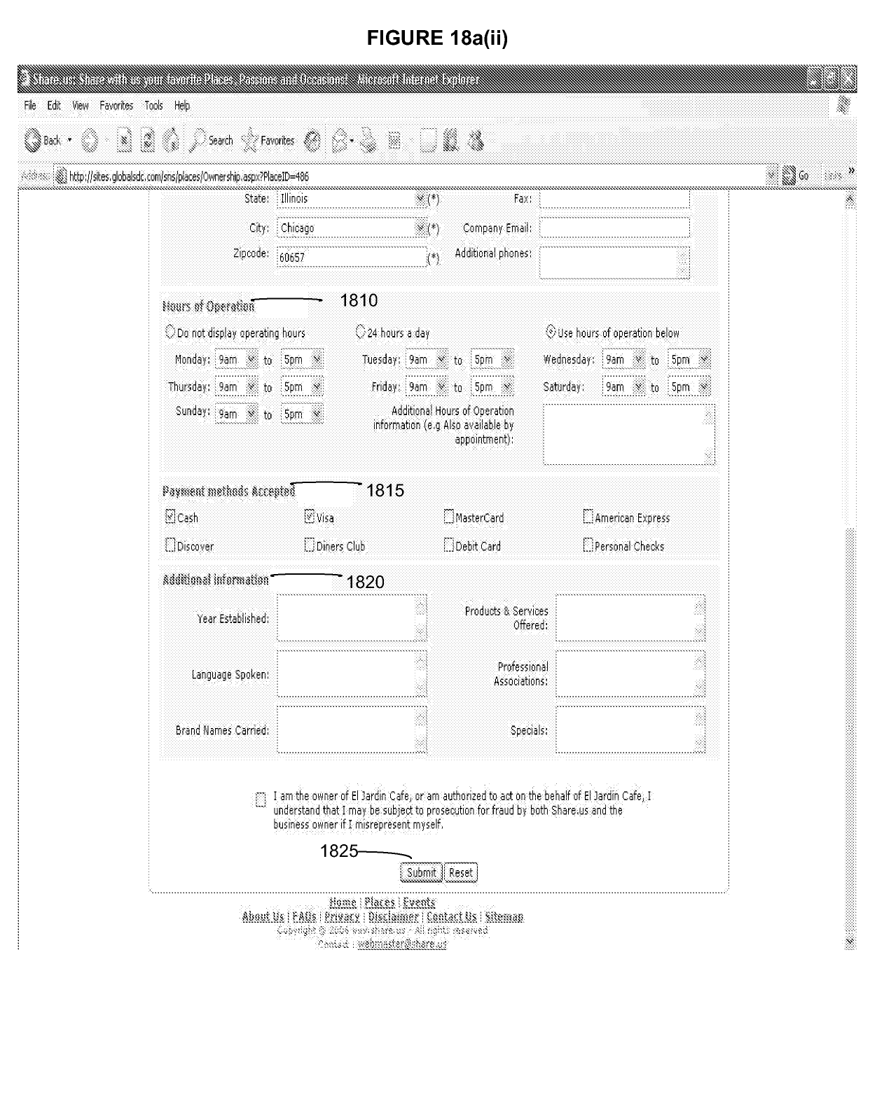

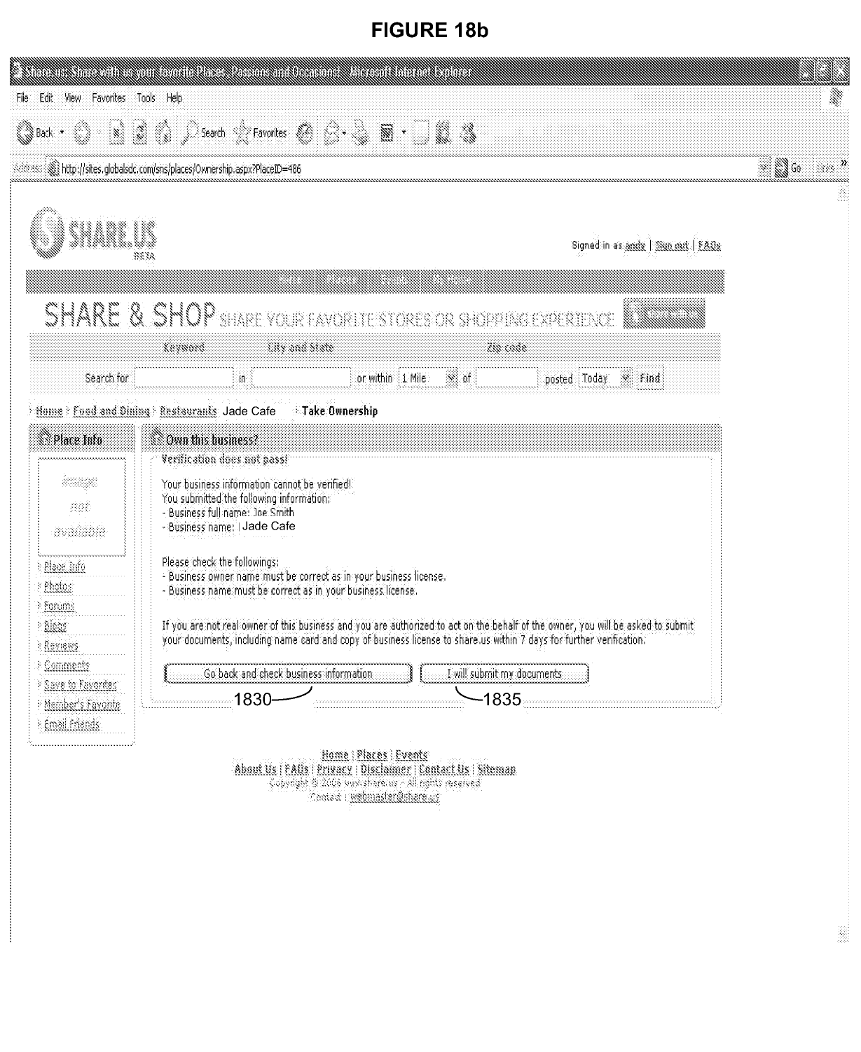

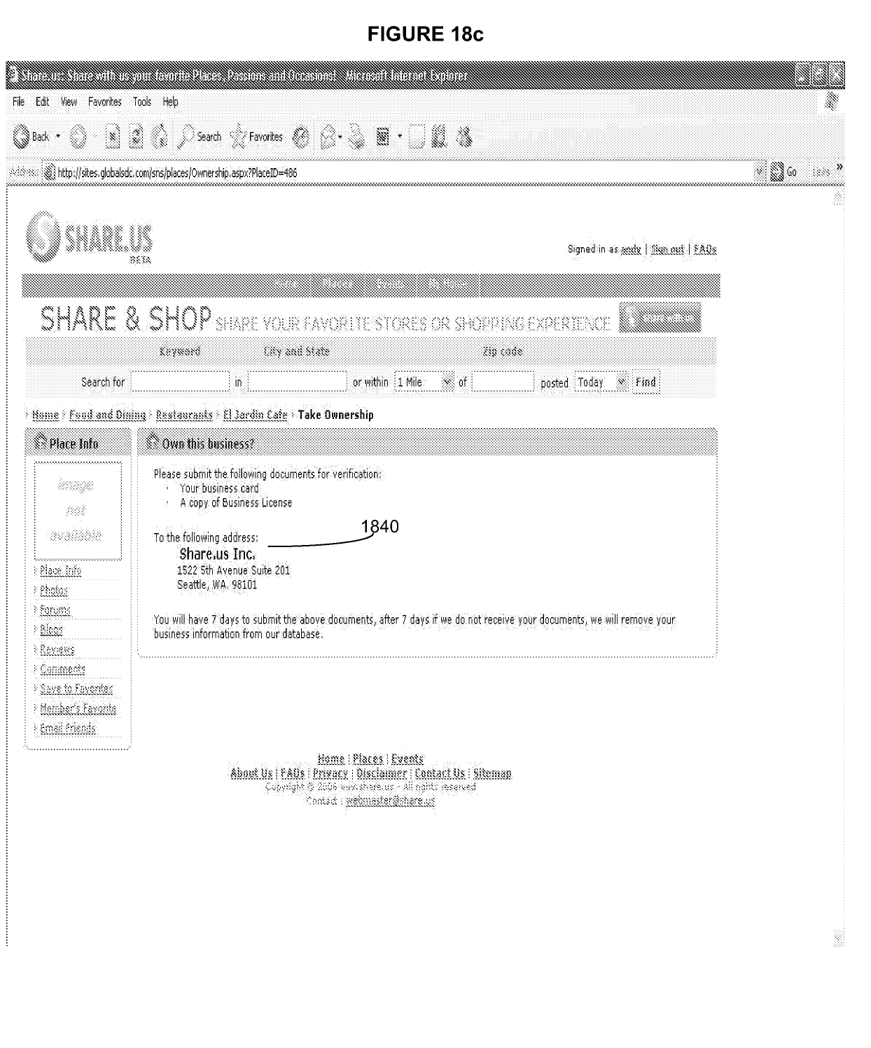

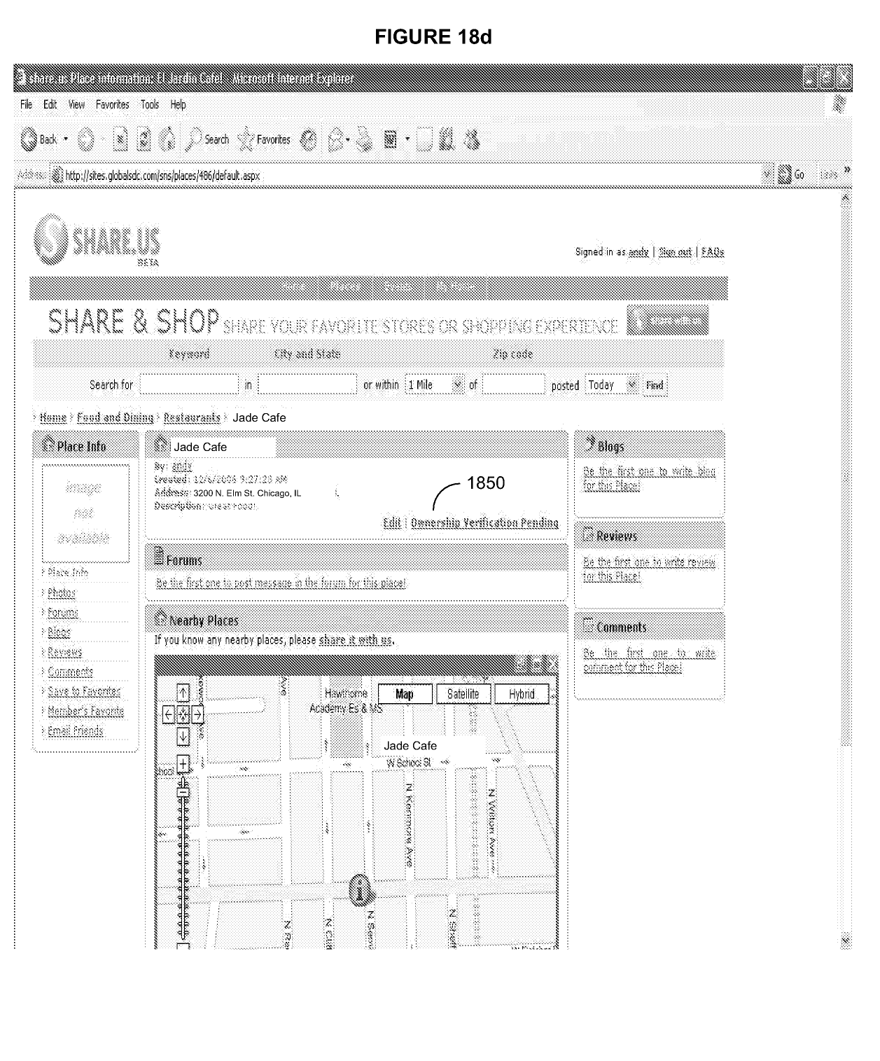

If a member claims to be the owner of the Place, then she can proceed to validate his ownership by clicking on the “Own this business” link 1780 on the Place Home Page. Clicking the “Own this business” link 1780 on the Place Home Page (See FIG. 17e) leads the member to the Take Ownership Web Page as shown in FIG. 18a. FIGS. 18a-d are diagrams of exemplary user interfaces allowing a member to verify her ownership status for generating business content, according to an embodiment of the present invention. FIG. 18a(i) is the top portion of the Take Ownership Web Page while FIG. 18a(ii) is the bottom portion. The member may enter business information that includes contact information 1800, location information 1805, hours of operation 1810, payment methods accepted 1815, and any other additional information 1820.

After entering all the business information, the member can click the “Submit” push button 1825 to have the website validate that she is the owner of the Place. This embodiment of the present invention validates the business information by first comparing it to its own business information database. If this comparison fails to verify the member as the Place owner, then the embodiment compares the business information to a third party database. If it still cannot verify that the member is the Place owner, it displays the web page shown in FIG. 18b stating ownership verification did not pass. The member can review her business information. If she detects an error then she can re-enter the business information by clicking the “Go back and check business information” push button 1830. However, if the member has entered the business information correctly, then her only recourse is to submit documents to the website to verify her ownership of the Place. She can do this by clicking the “I will submit my documents” push button 1835. This leads the member to view the web page shown in FIG. 18c displaying the contact information 1840 for the member to deliver her official documents. Viewing the Place Home Page as shown in FIG. 18d, the website displays that the Place ownership verification is pending 1850. Note, in an embodiment of the invention, if the member does not submit documents within a certain amount of days after registration, then the SNS-LSS website will remove the business information in one embodiment so that another member can take ownership of the place.

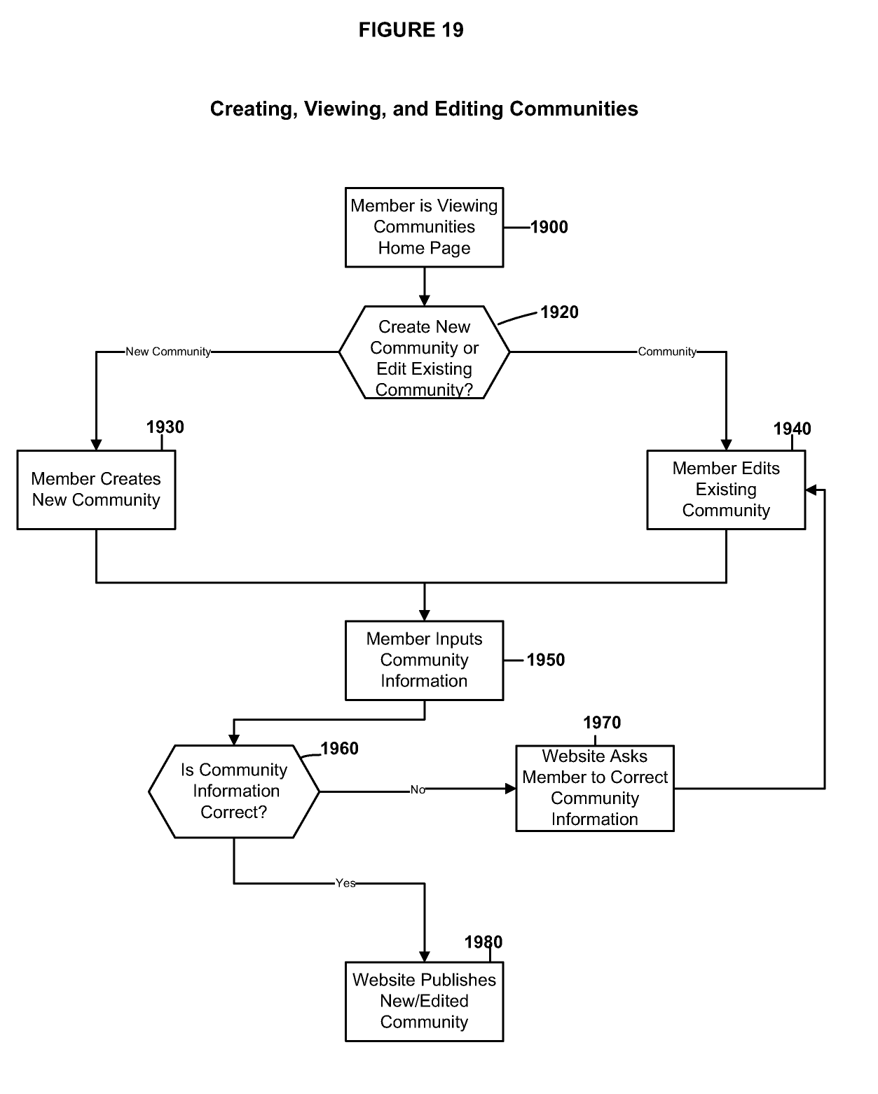

FIG. 19 is a flow diagram illustrating a method for allowing a member to generate Community content in accordance with an embodiment of the invention. First, a member views the Communities Home Page at stage 1900. A member can create a new Community or edit an existing Community (i.e., at stages 1920, 1930, and 1940). Once the member decides whether to create or edit a Community, the member inputs the Community information using the web and software tools provided by the SNS-LSS website at stage 1950. Next, the website validates the information at stage 1960. If the website finds an error in the entering of the Community information, it asks the member to correct it by editing the information at stage 1970. Common errors may include incorrectly typed names and topics of the Communities. Once the website validates the content information, it publishes the new or edited Community on the website at stage 1980.

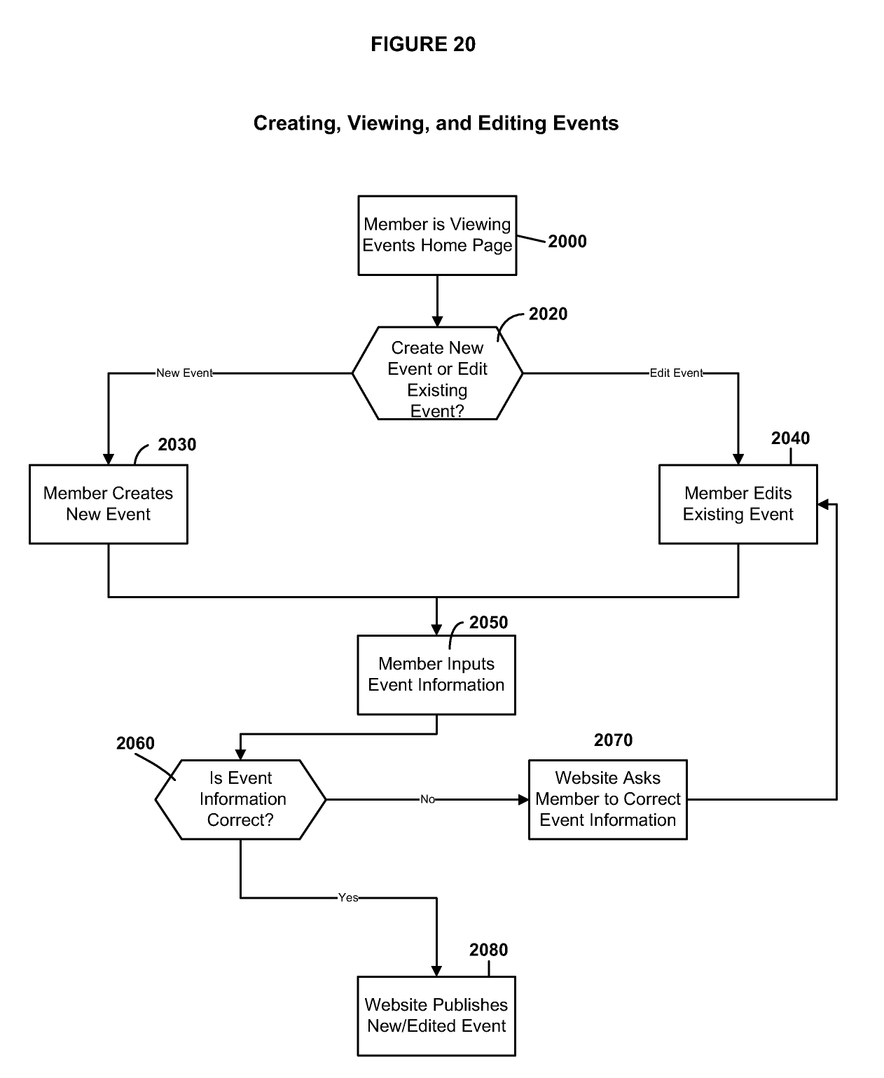

Similarly, FIG. 20 is a flow diagram illustrating a method for a member to generate Event content associated with business content, in accordance with an embodiment of the invention. First, a member views the Events Home Page at stage 2000. A member can create a new Event or edit an existing Event (i.e., at stages 2020, 2030, and 2040). Once the member decides whether to create or edit an Event, the member inputs the Event information using the web and software tools provided by the SNS-LSS website at stage 2050. Next, the website validates the information at stage 2060. If the website finds an error in the entering of the Event information, it asks the member to correct it by editing the information at stage 2070. A common error may include incorrectly typed names of the Events. However, once website validates the content information, it publishes the new or edited Event on the website at stage 2080.

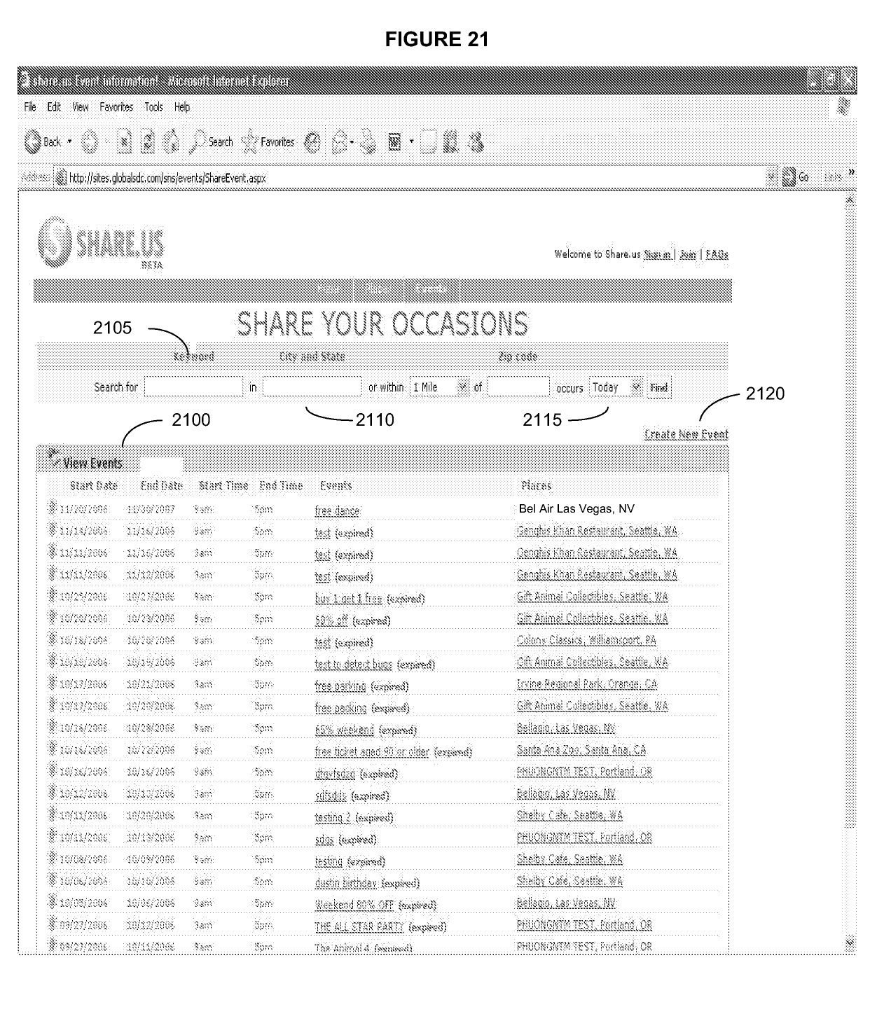

FIG. 21 is a diagram of an exemplary user interface for allowing a member to view, create, or edit Event content, according to an embodiment of the invention. Specifically, FIG. 21 is a screen shot of the Events Home Page. It lists all the Events 2100 on the SNS-LSS website, and allows the member to search for particular Events using keywords, addresses, and dates of the Event (2105, 2110, and 2115). Finally, it has a link to create a new Event 2120.

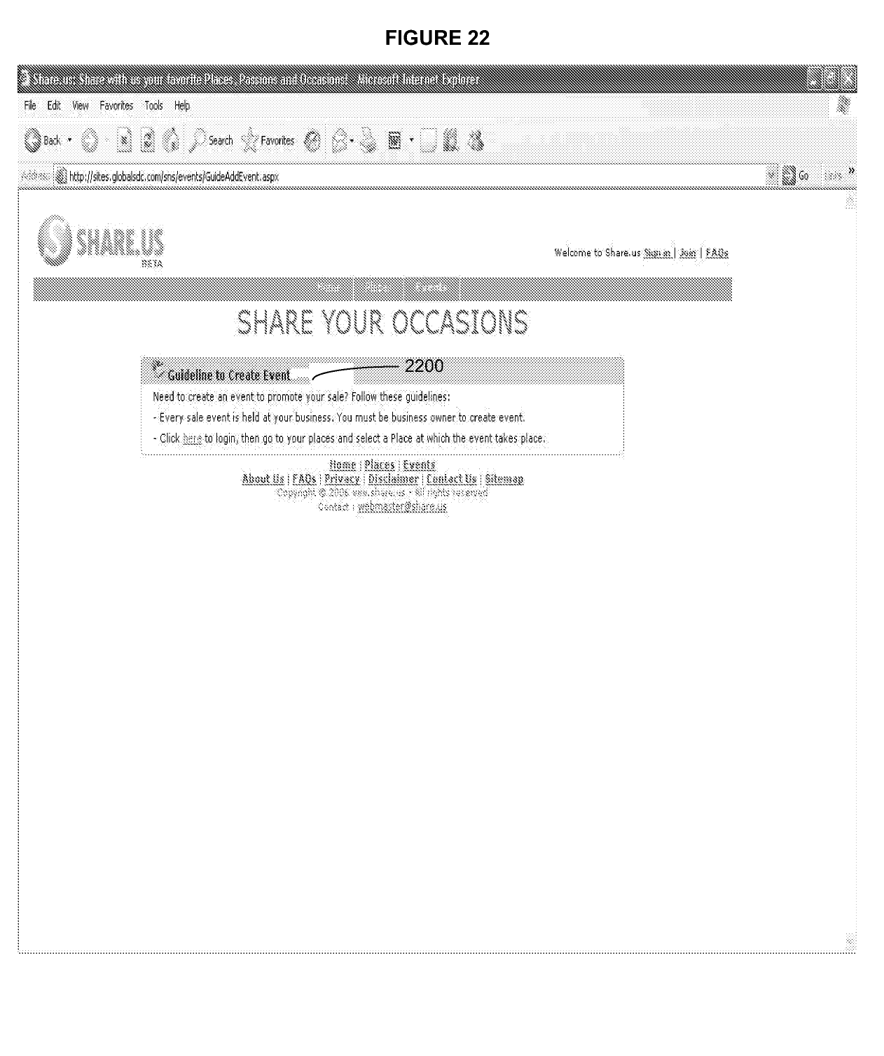

FIG. 22 is a diagram of an exemplary user interface setting forth the guidelines for authoring Event information for a business, according to an embodiment of the invention. As shown in FIG. 22 (this page is shown after clicking the “Create New event” link 2120 in FIG. 21) to create an Event for a Place a member needs to be a verified owner of the Place of the event 2200. This is one of the many features of being a Place owner on the SNS-LSS website in an embodiment of the invention. Other features may include editing business information, soliciting other business owners as potential customers or suppliers, and selling merchandise to fellow members and visitors.

It will be appreciated that a new and useful system for providing social networking and local searching has been described. The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of sharing online content among a group of two or more users over a network comprising:
receiving user identification information from a user at a computer and transmitting the received user identification information to a remote server, the user identification information being usable to identify the user as one of a member and an owner relative to a portion of content stored on a remote server;
receiving a request from the user of the computer to modify target data stored on the remote server, wherein the target data is viewable by each user of the group of two or more users, and transmitting the request to the remote server; and
receiving at the computer a response from the remote server, the response being selected from the group consisting of a verification that the content has been changed and a refusal to change the content; wherein a verification is received if the user is identified as an owner relative to the target data or if the user is identified as a member but the target data is determined to be non-critical data, and wherein otherwise a refusal is received.

2. The method according to claim 1, wherein the target data comprises at least one type of data selected from the group consisting of text data, photograph data, music data, and video data.

3. The method according to claim 1, wherein the target data comprises data associated with information regarding a business enterprise.

4. The method according to claim 3, wherein the data associated with information regarding a business enterprise comprises an address associated with the enterprise and information related to a product or service offered by the enterprise.

5. The method according to claim 4, wherein the target data further comprises data embodying a third party review of the product or service.

6. The method according to claim 3, wherein the target data further comprises information regarding the enterprise that has been supplied by a plurality of the group of two or more users.

7. The method according to claim 3, wherein the target data comprises a link usable by a member to purchase a product or service from the enterprise.

8. The method according to claim 2, wherein the target data comprises photograph data representative of a collection of a plurality of photographs.

9. The method according to claim 3, wherein the data comprises an advertisement related to a product or service provided by the enterprise.

10. The method according to claim 3, wherein the data comprises a notification of an event associated with the enterprise.

11. A computer-readable medium having stored thereon computer-readable instructions for sharing online content among a group of two or more users over a network comprising:
instructions for receiving user identification information from a user at a computer and transmitting the received user identification information to a remote server, the user identification information being usable to identify the user as one of a member and an owner relative to a portion of content stored on a remote server;
instructions for receiving a request from the user of the computer to modify target data stored on the remote server, wherein the target data is viewable by each user of the group of two or more users, and transmitting the request to the remote server; and
instructions for receiving at the computer a response from the remote server, the response being selected from the group consisting of a verification that the content has been changed and a refusal to change the content; wherein a verification is received if the user is identified as an owner relative to the target data or if the user is identified as a member but the target data is determined to be non-critical data, and wherein otherwise a refusal is received.

12. The computer-readable medium according to claim 11, wherein the target data comprises at least one type of data selected from the group consisting of text data, photograph data, music data, and video data.

13. The computer-readable medium according to claim 11, wherein the target data comprises data associated with information regarding a business enterprise.

14. The computer-readable medium according to claim 13, wherein the data associated with information regarding a business enterprise comprises an address associated with the enterprise and information related to a product or service offered by the enterprise.

15. The computer-readable medium according to claim 14, wherein the target data further comprises data embodying a third party review of the product or service.

16. The computer-readable medium according to claim 13, wherein the target data further comprises information regarding the enterprise that has been supplied by a plurality of the group of two or more users.

17. The computer-readable medium according to claim 13, wherein the target data comprises a link usable by a member to purchase a product or service from the enterprise.

18. The computer-readable medium according to claim 12, wherein the target data comprises photograph data representative of a collection of a plurality of photographs.

19. The computer-readable medium according to claim 13, wherein the target data comprises an advertisement related to a product or service provided by the enterprise.

20. The computer-readable medium according to claim 13, wherein the target data comprises a notification of an event associated with the enterprise.

21. A method of sharing online content among a group of two or more users over a network comprising:
receiving user identification information from a remote computer and storing it, the user identification information being usable to identify the user as one of a member and an owner relative to a portion of content stored on the server;
receiving a request from the remote computer to modify target data stored on the server;
determining whether the user is an owner relative to the target data; and
modifying the target data according to the request only if the user is identified as an owner relative to the target data or if the user is identified as a member but the target data is determined to be non-critical data.

22. The method according to claim 21, wherein determining whether the user is an owner relative to the target data comprises determining whether the user identification information matches identification information associated with a registered owner.

23. The method according to claim 21, wherein the user identification information does not match identification information associated with any registered owner, the method further comprising requesting that the user provide verification information.
